(19) United States
(12) Patent Application Publication
(10) Pub. No.: US 2025/0370088 A1
(43) Pub. Date: Dec. 4, 2025

(54) OBJECT SENSING USING 2D SCRAMBLED FMCW SIGNALS

(71) Applicant: QUALCOMM Incorporated, San Diego, CA (US)

(72) Inventors: Kangqi LIU, San Diego, CA (US); Weimin DUAN, San Diego, CA (US); Huilin XU, Temecula, CA (US)

(21) Appl. No.: 18/679,044

(22) Filed: May 30, 2024

(51) Int. Cl. G01S 7/02; G01S 7/35; G01S 13/00; G01S 13/536

(52) U.S. Cl. CPC G01S 7/0234; G01S 7/35; G01S 13/003; G01S 13/536

(57) ABSTRACT

Methods, devices, and systems pertaining to object sensing operations are disclosed herein. In one embodiment, a sensing device can perform a sensing operation by using a 2D modulated PC-FMCW signal for distinguishing a target object from signal artifacts. In another embodiment, a sensing device can perform a two-step sensing operation. A first step of the sensing operation involves using a PC-FMCW signal to sense a target object. If the target object is uniquely sensed and no signal artifacts are present, the second step can be omitted. If not, the second step can be used. The second step involves the use of a 2D scrambled FMCW signal that is based on a 2D modulation of an FMCW signal with a range-domain scrambling code and a Doppler-domain scrambling sequence. The target device may be uniquely sensed based on using the scrambling code and the scrambling sequence to demodulate an echo signal.

### BACKGROUND

### 1. Field of Disclosure

The present disclosure relates generally to the field of object sensing using radio frequency (RF) signals, and more specifically relates to object sensing operations performed by use of 2D scrambled FMCW signals encoded with two scrambling sequences.

### 2. Description of Related Art

The performance of RF sensing by wireless devices can have a wide range of consumer, industrial, commercial, and other applications. RF sensing can be used to determine the presence of a target object, determine the location of the target object, and/or track the movement of the target object over time. Cellular networks (e.g., fifth-generation (5G) new radio (NR) networks) and other types of wireless networks may be capable of performing RF sensing using base stations, user equipment (UEs), and/or other wireless devices communicatively coupled with the cellular network as “sensing nodes.” The quality of sensing operations performed by various sensing nodes can vary based on factors such as capabilities, configurations, and sensing techniques used.

### BRIEF SUMMARY

In some example embodiments described herein, a two-dimensional (2D) scrambled PC-FMCW signal can be generated based on scrambling of an FMCW signal with a range-domain scrambling code and a Doppler-domain scrambling sequence. The 2D modulated PC-FMCW signal can be used for performing interference mitigation in a sensing operation. One potential advantage of using the 2D modulated PC-FMCW signal pertains to enabling a user device to mitigate interference effects caused by signal artifacts during a sensing operation.

An example method for performing an object sensing operation includes determining a range-domain scrambling code; determining a Doppler-domain scrambling sequence; and performing the object sensing operation, the object sensing operation comprising at least one of transmitting or receiving a two-dimensional (2D) scrambled frequency modulated continuous wave (FMCW) signal encoded with the range-domain scrambling code and the Doppler-domain scrambling sequence.

An example method for performing an object sensing operation by a configuring device, the method comprising receiving a capability report from a sensing device; determining information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and transmitting the information to the sensing device.

An example apparatus for performing an object sensing operation, the apparatus comprising a transceiver; a memory; and one or more processors communicatively coupled with the transceiver and the memory, the one or more processors configured to receive a capability report from a sensing device; determine information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and transmit the information to the sensing device.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning/sensing system, according to an embodiment.

FIG. 2 is a diagram of a fifth-generation (5G) new radio (NR) positioning/sensing system, according to an embodiment.

FIG. 3 is a diagram showing an example of a radio frequency (RF) sensing system.

FIG. 4 illustrates an example interference scenario that may be encountered during a sensing operation in accordance with the disclosure.

FIGS. 5A through 5C illustrate time domain and frequency domain characteristics of three types of sensing signals that can be used for sensing operations.

FIGS. 6A and 6B illustrate the effect of PC code length upon the spectral characteristics of a PC-FMCW signal in comparison to a spectral characteristic of a FMCW signal.

FIGS. 7A and 7B illustrate the effect of PC code length upon range estimation using a PC-FMCW signal.

FIGS. 8A through 8C illustrate a sensing operation sequence in accordance with an embodiment.

FIG. 9A shows some example functional blocks of a 2D scrambled FMCW transceiver in accordance with an embodiment.

FIG. 9B illustrates an example multi-static configuration that may be used for performing various operations in accordance with the disclosure.

FIG. 10 illustrates a first example sense signal transmission sequence in accordance with an embodiment.

FIG. 11 illustrates a second sense signal transmission sequence in accordance with an embodiment.

FIG. 12 shows a flowchart of a method for performing an object sensing operation by a sensing device in accordance with the disclosure.

FIG. 13 shows a block diagram of a user equipment in accordance an embodiment of the disclosure.

FIG. 14 is a block diagram of a network node in accordance an embodiment of the disclosure.

FIG. 15 is a block diagram of an embodiment of a computer system, which may be used, in whole or in part, to provide the functions of one or more components and/or devices as described in the embodiments herein.

FIG. 16 illustrates an example message flow that may be associated with performing an object sensing operation in accordance with the disclosure.

FIG. 17 shows a flowchart of a method for performing an object sensing operation by a configuring device in accordance with the disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

Some words such as “encoding” and “modulating” may be used herein in an interchangeable manner. Furthermore, as used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” “position determination,” “object detection,” and variants refer to a process by which one or more objects are detected using RF signals transmitted by a transmitting device and, after reflecting from the one or more objects, received by a receiving device. Words such as “sense” and “detect” may be used interchangeably and generally refer to activities such as, for example, determining the presence of a target object, determining the location of the target object, and/or tracking the movement of the target object over time. In a monostatic configuration, the transmitting and receiving devices are the same device. In a bistatic configuration, one device transmits RF signals, and another device receives reflections of the RF signals from one or more objects. In multi-static configuration, one or more receiving devices are separate from one or more transmitting devices. As used herein, the term “static” in the terms “monostatic,” “bistatic,” and “multistatic” (or “multi-static”) are meant to conform with historical literature on RF sensing but are not limited to “static” or stationary sensing nodes. As described herein, in some embodiments, sensing nodes may be mobile. As described herein, devices performing RF sensing may be referred to as “RF sensing nodes” or simply “sensing nodes.” In a bistatic or multi-static configuration, transmitting devices may be referred to as “transmitting nodes,” “Tx sensing nodes,” or “Tx nodes,” and receiving devices may be referred to as “receiving nodes,” “Rx sensing nodes,” or “Rx nodes.” As described hereafter in more detail, a receiving device can make measurements of these reflected RF signals to determine one or more characteristics of the one or more objects, such as location, range, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “reference signals” and the like may be used to refer to signals used for positioning of a user equipment (UE), sensing of active and/or passive objects by one or more sensing nodes, or a combination thereof. As described in more detail herein, such signals may comprise any of a variety of signal types. This may include but is not limited to, a positioning reference signal (PRS), sounding reference signal (SRS), synchronization signal block (SSB), channel start information reference signal (CSI-RS), or any combination thereof.

Techniques provided herein may apply to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHz) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects of wireless communication.

As noted, RF sensing may be performed by wireless devices or sensing nodes and can have a wide range of consumer, industrial, commercial, and other applications. Various aspects described herein generally relate to object sensing operations that are generally carried out by using FMCW (frequency modulated continuous wave) and PC-FMCW (phase-coded frequency modulated continuous wave) signals.

Particular aspects of the subject matter described in this disclosure can be implemented to realize one or more of the following advantages. In some embodiments, a two-dimensional (2D) scrambled PC-FMCW signal can be generated based on scrambling of an FMCW signal with a range-domain scrambling code and a Doppler-domain scrambling sequence. The 2D modulated PC-FMCW signal can be used for performing interference mitigation in a sensing operation. One potential advantage of using the 2D modulated PC-FMCW signal pertains to enabling a user device to mitigate interference effects caused by signal artifacts during a sensing operation. The signal artifacts may be observed during a sensing operation as a result of, for example, concurrent sensing operations performed by other devices (either unintentionally or with malignant intent).

In an example embodiment, a sensing device can perform a sensing operation by using a 2D modulated PC-FMCW signal for sensing one or more objects and for distinguishing a target object from signal artifacts. In another example embodiment, a sensing device can perform a two-step sensing operation by using a combination of a FMCW signal and a 2D modulated PC-FMCW signal. The two-step sensing operation may include a first step wherein a frequency modulated continuous wave (FMCW) signal is used to sense a target object. If the target object is uniquely sensed and no signal artifacts are present, the second part of the two-step sensing operation can be omitted. However, if signal artifacts are sensed in this first step and the target object is not uniquely identifiable, a second step of the two-step sensing operation may be performed. The second step involves the use of a 2D scrambled FMCW signal that can be generated based on a 2D modulation of an FMCW signal with a range-domain scrambling code and a Doppler-domain scrambling sequence. The target device may be uniquely sensed, based on using the range-domain scrambling code and the Doppler-domain scrambling sequence to demodulate an echo signal. A discussion of various example embodiments is provided below after a brief discussion of relevant technology and context/background in which embodiments may be used.

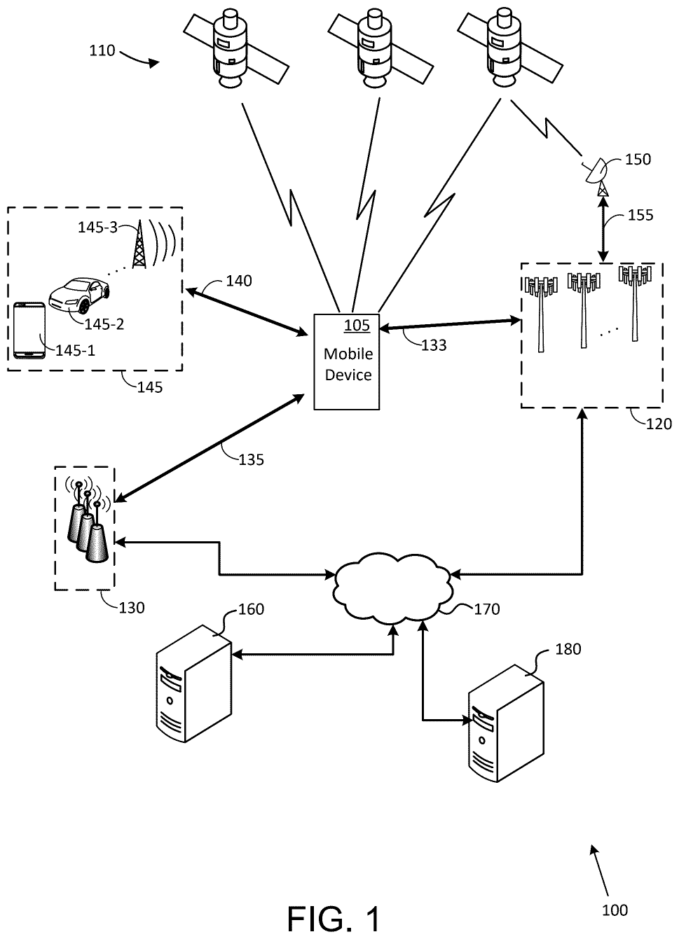

FIG. 1 is a simplified illustration of a positioning/sensing system 100, which may be implemented in conjunction with and/or as part of a wireless communication system (e.g., cellular communication network) which includes a mobile device 105, location/sensing server 160, and/or other components of the positioning/sensing system 100. The techniques described herein may be implemented by one or more components of the positioning/sensing system 100, however the techniques described herein are not limited to such components and may be implemented in other types of systems (not shown). The positioning/sensing system 100 can include: the mobile device 105; one or more satellites 110 (also referred to as space vehicles (SVs)) for a Global Navigation Satellite System (GNSS) (such as the Global Positioning System (GPS), GLONASS, Galileo or Beidou) and/or Non-Terrestrial Network (NTN) functionality; base stations 120; access points (APs) 130; location/sensing server 160; network 170; and external client 180. Generally put, the positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or to perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated, as necessary. Specifically, although only one mobile device 105 is illustrated, it will be understood that many UEs (e.g., hundreds, thousands, millions, etc.) may utilize the positioning/sensing system 100. Similarly, the positioning/sensing system 100 may include a larger or smaller number of base stations 120 and/or APs 130 than illustrated in FIG. 1. The illustrated connections that connect the various components in the positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location/sensing server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G, and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base stations 120 may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), a New Radio (NR) NodeB, a Next Generation Node B (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components.

An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location/sensing server 160, by accessing the network 170 via a base station 120 using a first communication link 133. Additionally or alternatively, because APs 130 also may be communicatively coupled with the network 170, mobile device 105 may communicate with network-connected and Internet-connected devices, including location/sensing server 160, using a second communication link 135, or via one or more other mobile devices 145. As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server that may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location/sensing server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location/sensing server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location/sensing server 160. In some embodiments, the location/sensing server 160 may comprise, a Discovered SLP (D-SLP) or an Emergency SLP (E-SLP). The location/sensing server 160 may also comprise an Enhanced Serving Mobile Location Center (E-SMLC) that supports location of mobile device 105 using a control plane (CP) location solution for LTE radio access by mobile device 105. The location/sensing server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location/sensing server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning/sensing system 100 (e.g., satellites 110, APs 130, base stations 120). The estimated location of the mobile device 105 can be estimated geometrically (e.g., using multiangulation and/or multilateration), based on the distance (range) and/or angle measurements, along with known position of the one or more components.

Additionally or alternatively, the location/sensing server 160, may function as a sensing server. A sensing server can be used to coordinate and/or assist in the coordination of sensing of one or more objects (also referred to herein as “targets”) by one or more wireless devices in the positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF or SnMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As previously noted, the example positioning/sensing system 100 can be implemented using a wireless communication network, such as an LTE-based or 5G NR-based network, or a future 6G network.

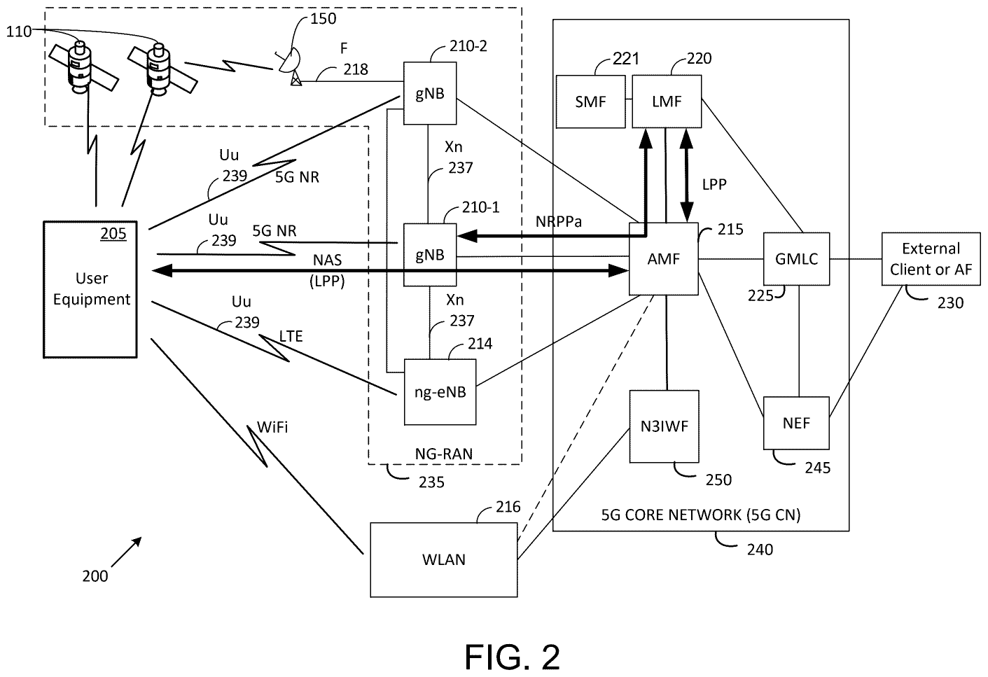

FIG. 2 shows a diagram of a 5G NR positioning/sensing system 200, illustrating an embodiment of a positioning/sensing system (e.g., positioning/sensing system 100) implemented in 5G NR. The 5G NR positioning/sensing system 200 may be configured to enable wireless communication, determine the location of a UE 205 (which may correspond to the mobile device 105 of FIG. 1), perform RF sensing, or a combination thereof, by using access nodes, which may include NR NodeB (gNB) 210-1 and 210-2 (collectively and generically referred to herein as gNBs 210), ng-eNB 214, and/or WLAN 216 to implement one or more positioning methods. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR positioning/sensing system 200 additionally may be configured to determine the location of a UE 205 by using an LMF 220 (which may correspond with location/sensing server 160) to implement the one or more positioning methods. The SMF 221 may coordinate RF sensing by the 5G NR positioning/sensing system 200. Here, the 5G NR positioning/sensing system 200 comprises a UE 205, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning/sensing system 200 are described below. The 5G NR positioning/sensing system 200 may include additional or alternative components.

The 5G NR positioning/sensing system 200 may further utilize information from satellites 110. As previously indicated, satellites 110 may comprise GNSS satellites from a GNSS system like Global Positioning/sensing system (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted, as necessary. Specifically, although only one UE 205 is illustrated, it will be understood that many UEs (e.g., hundreds, thousands, millions, etc.) may utilize the 5G NR positioning/sensing system 200. Similarly, the 5G NR positioning/sensing system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning/sensing system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning/sensing system 200, such as the LMF 220 and AMF 215.

5G NR positioning/sensing system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning/sensing system 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, WLAN 216, or NTN satellite 110) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a location of the UE 205) may be performed at the UE 205 (e.g., by measuring downlink PRS (DL-PRS) signals transmitted by wireless nodes such as gNB 210, ng-eNB 214, WLAN 216, or NTN satellite 110, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE-based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location-related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE-assisted or UE-based positioning of UE 205 by LMF 220.

In a 5G NR positioning/sensing system 200, positioning and sensing methods can be categorized as being “UE assisted” or “UE based.” This may depend on where the request for determining the position of the UE 205 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 205 may obtain location measurements and send the measurements to a location server (e.g., LMF 220) for computation of a location estimate for UE 205. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 205 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 205 may obtain location measurements (e.g., which may be the same as or similar to location measurements for a UE-assisted position method) and may further compute a location of UE 205 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 205, and/or may receive measurements obtained by UE 205 or by an AP in WLAN 216 in the case of N3IWF 250, and may send the measurements to a location server (e.g., LMF 220) for computation of a location estimate for UE 205.

Positioning of the UE 205 also may be categorized as UL, DL, or DL-UL based, depending on the types of signals used for positioning. If, for example, positioning is based solely on signals received at the UE 205 (e.g., from a base station or other UE), the positioning may be categorized as DL based. On the other hand, if positioning is based solely on signals transmitted by the UE 205 (which may be received by a base station or other UE, for example), the positioning may be categorized as UL based. Positioning that is DL-UL based includes positioning, such as RTT-based positioning, which is based on signals that are both transmitted and received by the UE 205. Sidelink (SL)-assisted positioning comprises signals communicated between the UE 205 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

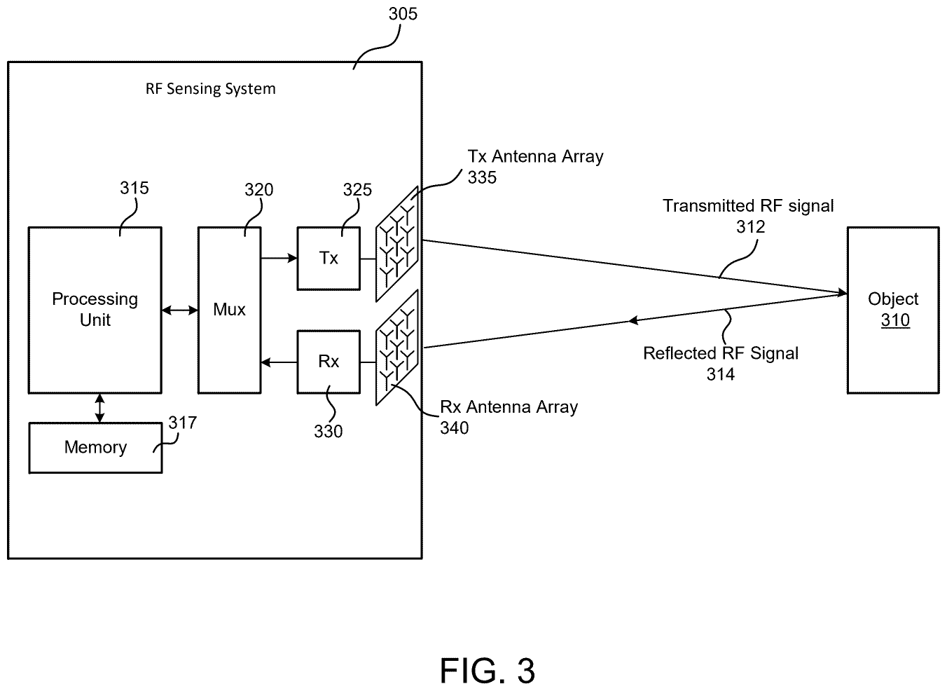

The principles described above with respect to UE-assisted positioning, UE-based positioning, UL-based positioning, DL-based positioning, and DL-UL based positioning may be generally extended to RF sensing. That is, RF sensing may be UE-based (e.g., originated from the UE) and/or UE assisted (e.g., originated from a non-UE entity), and may involve UL signals, DL signals, or both. However, RF sensing may differ from positioning in various ways. For example, as previously noted, RF sensing may involve the use of positioning reference signal (PRS), sounding reference signal (SRS), synchronization signal block (SSB), channel start information reference signal (CSI-RS), or any combination thereof. Further, RF sensing may be performed in a monostatic, bistatic, or multi-static manner, as described above, where RF sensing nodes comprise a UE (e.g., UE 205) and/or one or more access nodes (e.g., gNBs 210, ng-eNB 214, WLAN 216, NTN satellites 110, or any combination thereof). Various aspects of RF sensing are described below FIG. in more detail with respect to FIG. 3.

FIG. 3 is a diagram showing an example of an RF sensing system 305 and associated terminology. As used herein, the terms “waveform” and “sequence” and derivatives thereof are used interchangeably to refer to RF signals generated by a transmitter of the RF sensing system 305 and received by a receiver of the RF sensing system 305 for object detection. A “pulse” and derivatives thereof are generally referred to herein as waveforms comprising a sequence or complementary pair of sequences transmitted and received to generate a channel impulse response (CIR). The RF sensing system 305 may comprise a standalone device such as, when the mobile device 105 is a standalone device (a mobile phone, for example), or may be integrated into a larger electronic device such as, for example, the UE 205 described above. It can be noted that although the example RF sensing system 305 of FIG. 3 is illustrated in a monostatic configuration, embodiments are not so limited. As noted elsewhere herein, RF sensing nodes may be configured to perform RF sensing in a monostatic, bistatic, or multi-static configuration, or any combination thereof (e.g., depending on the circumstances of a particular instance). As such, components of an RF sensing system 305 within an RF sensing node may vary. For example, RF sensing nodes performing only transmitting or only receiving during RF sensing may include only respective components related to the transmitting or receiving. Again, embodiments may vary, depending on desired functionality.

With regard to the functionality of the RF sensing system 305 in FIG. 3, the RF sensing system 305 can detect the distance, direction, and/or speed of an object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305.

To enable RF sensing, RF sensing system 305 may include a processing unit 315, memory 317, multiplexer (mux) 320, Tx processing circuitry 325, and Rx processing circuitry 330. (The RF sensing system 305 may include additional components not illustrated, such as a power source, user interface, or electronic interface). It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signals 312. Likewise, the terms “receive circuitry” or “Rx circuitry” refer to any circuitry utilized to detect and/or process the reflected RF signals 314. As such, “transmit circuitry” and “receive circuitry” may not only comprise the Tx processing circuitry 325 and Rx processing circuitry 330 respectively but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx processing circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna array 340), a mixer configured to perform FMCW demodulation, a filter to block undesired signals in the mixer output, an analog-to-digital converter (ADC) for digitizing the demodulated signal, and a pulse correlator providing a matched filter for the pulse generated by the Tx processing circuitry 325. The pulse correlator may further include circuitry for processing the received signal by use of a phase code that can be used for generating the transmitted sense signal. The Rx processing circuitry 330 may use the correlator output as the CIR, which can be processed by the processing unit 315 (or other circuitries). Processing of the CIR may include object detecting, range, speed, or direction of arrival (DoA) estimation.

Beamforming is further enabled by a Tx antenna array 335 and an Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signals 312 may vary, depending on the technologies utilized. Techniques provided herein can apply generally to “mm Wave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize RF signals with frequencies outside this range. For example, in some embodiments, 5G frequency bands (e.g., 28 GHz) may be used.

Because RF sensing may be performed in the same frequency bands as communication (e.g., cellular and/or WLAN communication), hardware may be utilized for both communication and RF sensing, as previously noted. For example, one or more of the components of the RF sensing system 305 shown in FIG. 3 may be included in a wireless modem (e.g., Wi-Fi, 5G, or other modems). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 communication technology), embodiments may leverage channel estimation used in communication for performing the RF sensing as provided herein. Accordingly, the pulses may be the same as those used for channel estimation in communication.

As noted, the RF sensing system 305 may be integrated into an electronic device in which RF sensing is desired. For example, the RF sensing system 305, which can perform RF sensing, may be part of communication hardware found in modern mobile phones. Other devices, too, may utilize the techniques provided herein. These can include, for example, other mobile devices (e.g., tablets, portable media players, laptops, wearable devices, other electronic devices (e.g., security devices, on-vehicle systems, specialized or dedicated RF sensing devices), wireless nodes of the communication network (e.g., access nodes, such as base stations and/or satellites), or the like. That said, electronic devices (e.g., RF sensing nodes) into which an RF sensing system 305 may be integrated are not limited to such devices.

In RF sensing, a wireless signal can be transmitted from one or multiple transmit points and received at one or multiple receive points after being reflected off a target. RF sensing can enable many candidate applications, including intruder detection, animal/pedestrian/unmanned aerial vehicle (UAV) intrusion detection in highways and railways, rainfall monitoring, flooding awareness, autonomous driving, automated guided vehicle (AGV) detection/tracking/collision avoidance, smart parking and assistance, UAV trajectory and tracking, crowd management, sleep/health monitoring, gesture recognition, XR streaming, public safety, search and rescue, and more. Further, RF sensing is expected to be incorporated into wireless standards (e.g., 6G), and therefore may be performed in the future in a cellular network.

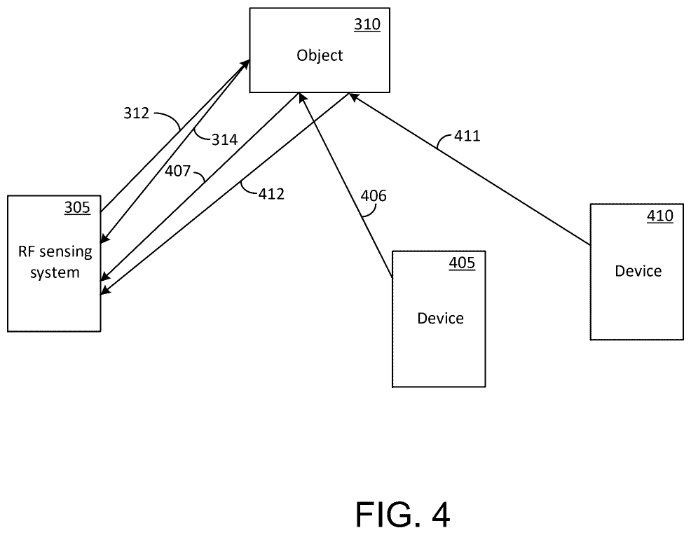

FIG. 4 illustrates an example interference scenario that may be encountered during a sensing operation performed by the RF sensing system 305 in accordance with the disclosure. As described above, the RF sensing system 305 can detect the distance, direction, and/or speed of the object 310 by generating a series of transmitted RF signals 312 (comprising one or more pulses). Some of these transmitted RF signals 312 reflect off of the object 310, and these reflected RF signals 314 (or “echoes”) are then processed by the RF sensing system 305 using beamforming (BF) and digital signal processing (DSP) techniques to determine the object's location (azimuth, elevation, velocity (e.g., from Doppler measurements), and range) relative to the RF sensing system 305. In the example interference scenario, one or more other devices such as, for example, a device 405 and a device 410 can be performing a sensing operation and/or a malignant operation (jamming, for example) at substantially the same time as when the RF sensing system 305 is sensing the object 310. Though, two devices are shown in this example scenario, in other example scenarios a single device or more than two devices may be causing the interference described below.

More particularly, the device 405 transmits RF signals 406 that may reflect off the object 310. Some or all of the reflected signal 407 may be received by the RF sensing system 305 and may be detected by the RF sensing system 305 in the form of a first signal artifact. Similarly, the device 410 transmits RF signals 411 that may reflect off the object 310. Some or all of the reflected signals 412 may be received by the RF sensing system 305 and may be detected by the RF sensing system 305 in the form of a second signal artifact.

The RF sensing system 305 is configured in accordance with the disclosure to obtain position information of the object 310 based on mitigating interference caused by such signal artifacts. The configuration of the RF sensing system 305 to perform the sensing operation is described below in further detail.

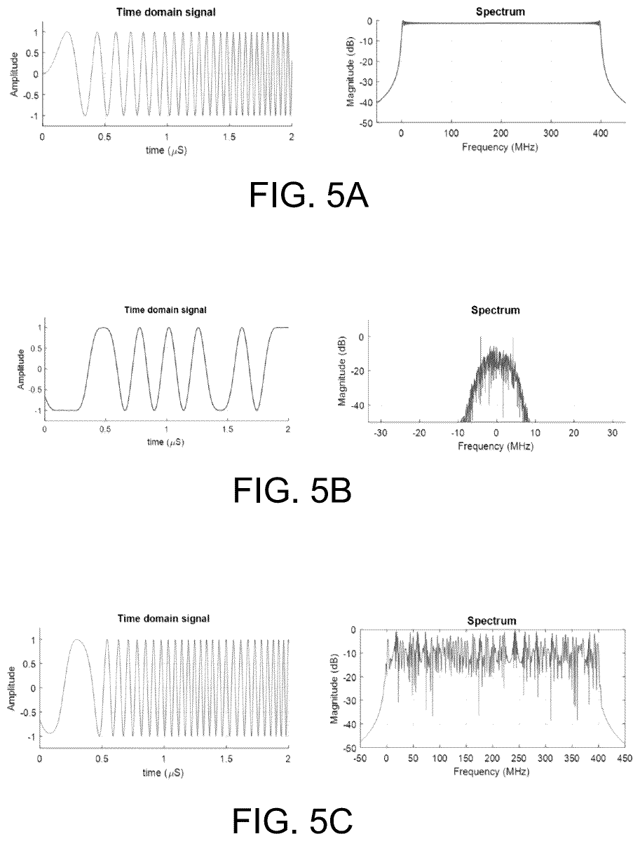

FIGS. 5A through 5C illustrate time domain and frequency domain characteristics of three types of signals that may be used for sensing operations. More particularly, FIG. 5A illustrates time domain and frequency domain characteristics of a wideband frequency modulated continuous wave (FMCW) signal. The amplitude of the FMCW signal is substantially flat across a wide frequency spectrum (in this example, the bandwidth spans around 400 MHz).

The wideband FMCW signal provides certain benefits for use in sensing operations such as, for example, low implementation costs, low peak-to-average-power-ratio (PAPR), and low complexity full duplex sensing operations. However, for dense sensing scenarios in cellular systems, wherein a large number of sensing nodes may have to share the same time and frequency resources, different sensing nodes may be compelled to use identical FMCW parameters (such as, for example, an identical chirp slope) thereby leading to interference issues in some operating environments. Furthermore, sensing systems that use wideband FMCW sense signals can suffer from issues such as, for example, limited cross-node interference mitigation when multiple sending nodes are conducting sensing operations using FMCW sense signals.

FIG. 5B illustrates time domain and frequency domain characteristics of a phase modulated continuous wave (PMCW) signal produced by modulating a continuous wave (CW) signal with a phase-code. In this example, the PMCW signal has a narrow-band spectrum having a 20 MHz bandwidth (+/−10 MHz). The narrowband PMCW signal provides certain benefits for use in sensing operations such as, for example, a certain level of cross-node interference mitigation when multiple sending nodes are conducting sensing operations using PMCW sense signals. However, sensing systems that use narrowband PMCW sense signals can suffer from issues such as, for example, high implementation costs and system complexity.

FIG. 5C illustrates a PC-FMCW signal that is based on modulating the FMCW signal shown in FIG. 5A with a phase code. The PC-FMCW signal inherits the properties of both an FMCW signal (example shown in FIG. 5A) and a PMCW signal (example shown in FIG. 5B). The spectrum of the PC-FMCW signal extends over the range of the FMCW signal shown in FIG. 5A and has a noise-like envelope caused by the PMCW signal.

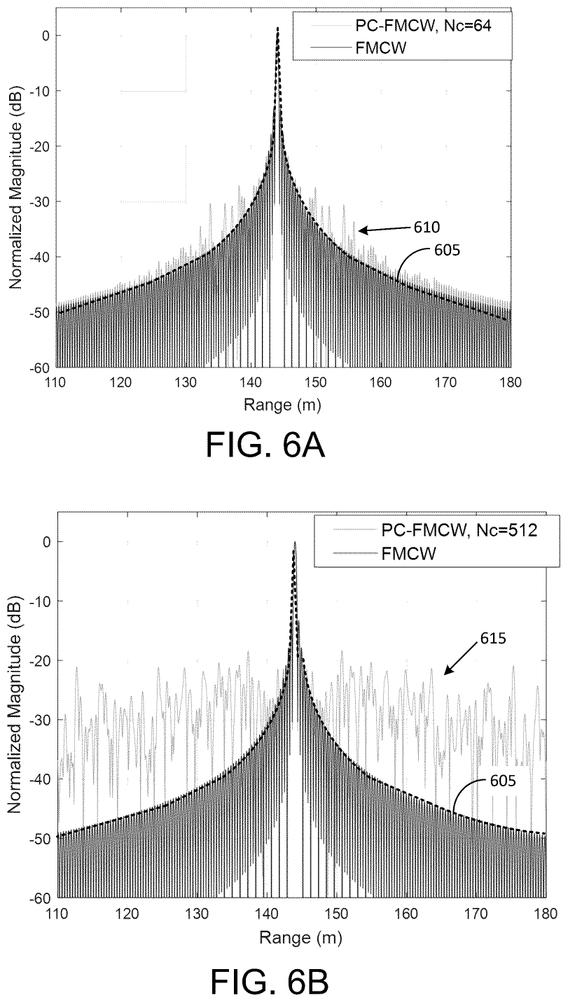

FIGS. 6A and 6B illustrate the effect of PC code length upon the spectral characteristics of a PC-FMCW signal in comparison to a spectral characteristic of a FMCW signal. FIG. 6A illustrates spectral characteristics wherein an FMCW signal is modulated with a PC code of length (Nc) of 64. The envelope 605 of the spectrum corresponding to the FMCW signal is modified to a noisy envelope 610 corresponding to the PC-FMCW signal.

FIG. 6B illustrates spectral characteristics wherein an FMCW signal is modulated with a PC code of length (Nc) of 512. The envelope 605 of the spectrum corresponding to the FMCW signal is modified to a noisy envelope 615 corresponding to the PC-FMCW signal. The amplitude of the noisy envelope 615 is higher than that of the noisy envelope 610 as a result of the increase in code length.

In general, a range resolution parameter of a sensing procedure performed by use of a FMCW signal is the same as that when using an PC-FMCW signal. However, increasing the code length (Nc), such as for example by increasing the code length per chirp, raises the sidelobes present in the PC-FMCW signal. When the code length (Nc) is small, the side lobe level of the PC-FMCW signal can be marginally higher than the side lobe level of an FMCW signal, and vice-versa. The side lobe level generally contributes to the signal-to-interference ratio (SIR) of the PC-FMCW signal. More particularly, the SIR is inversely proportional to the length of the phase code used for producing the PC-FMCW signal. The length of phase code can correspond to a numeric code selected for the phase code. The Doppler-domain scrambling sequence can also correspond to a numeric code sequence used by the wideband FMCW source 935 for producing the FMCW signal provided to the 2D scrambler 920.

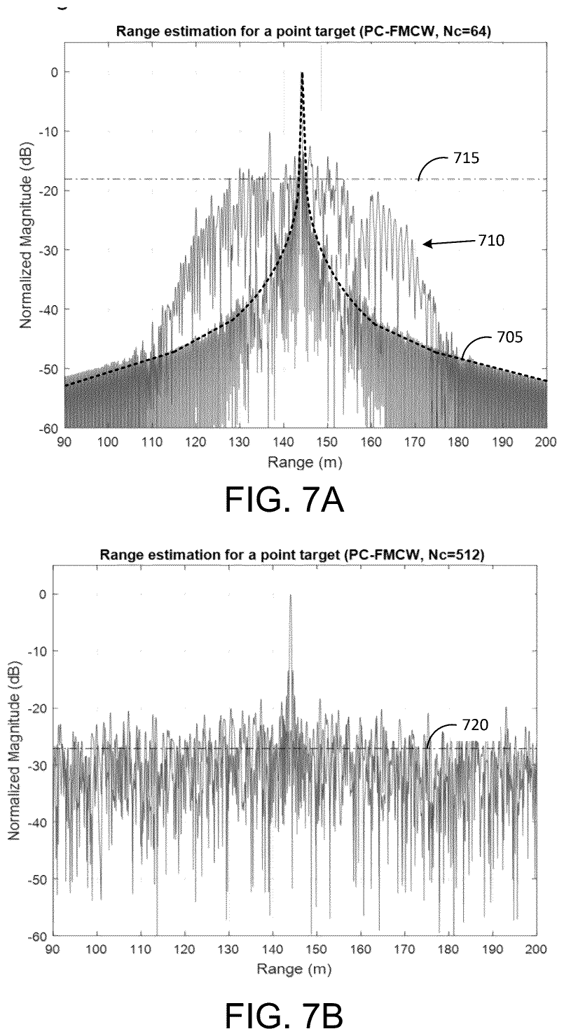

FIGS. 7A and 6B illustrate the effect of PC code length upon range estimation using a PC-FMCW signal. FIG. 7A illustrates range estimation for a point target using a PC-FMCW signal with a code length (Nc) of 64. In general, a phase code spreads the spectrum/energy of a decoded PC-FMCW signal and suppresses a peak power of the encoded PC-FMCW signal. Spreading the spectrum allows interference mitigation to be performed. For example, a PC-FMCW signal that is decoded by use of an accurate phase code can be represented by an envelope 705, while a decoding performed by use of an incorrect phase code is hampered due to a noisy envelope 710. Range estimation may be characterized by use of an interference mitigation parameter that is based on a signal-to-interference (SIR) ratio. A theoretical limit to interference suppression can be determined based on an equation dB=10 log₁₀ (Nc). In the example illustrated in FIG. 7A, the theoretical limit is indicated by a line 715 corresponding to around −18 dB.

Use of a longer length phase code, such as illustrated in FIG. 7B, pertains to range estimation for a point target by use of a PC-FMCW signal with a phase code length (Nc) of 512. In this case, the spectrum is spread out over a wider range than in the case where the phase code length is 64 (FIG. 7A), and the theoretical limit to interference suppression is indicated by a line 720 corresponding to around −28 dB. Thus, a trade-off exists between a level of interference mitigation that can be achieved and an amount of spectral spread (side lobes), based on the choice of the phase code length (Nc). Increasing the level of interference mitigation based on increasing spectral spread allows for higher level of interference mitigation at the expense of factors such as noise. However, a higher level of interference mitigation may be achieved in some implementations by use of special techniques such as, for example, by use of a constant false alarm rate (CFAR) algorithm.

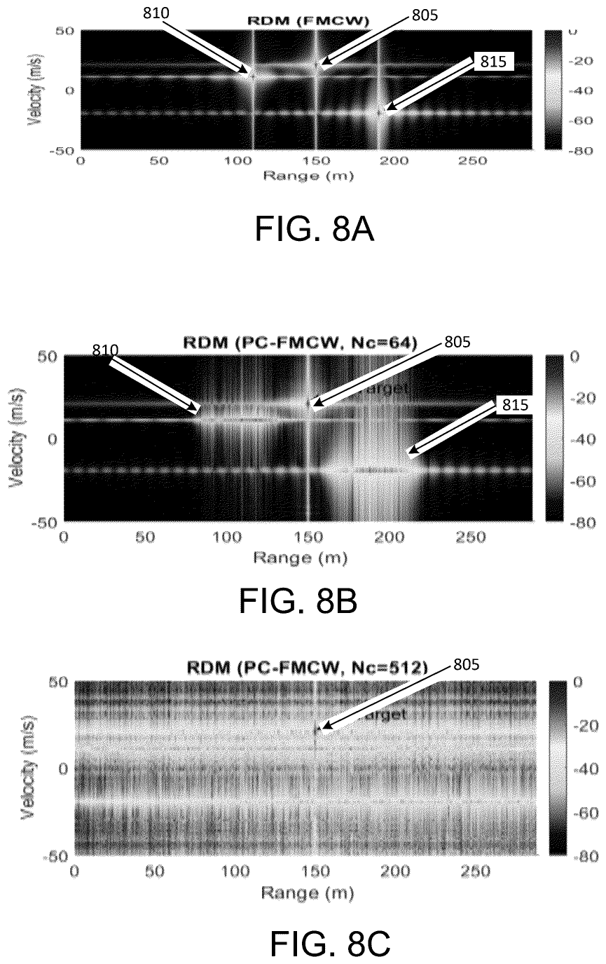

FIGS. 8A through 8C illustrate a sensing operation sequence in accordance with an embodiment. FIG. 8A illustrates an example representation of echoes obtained during a sensing procedure carried out by use of a FMCW signal (as may be done in traditional practice). In this example, the spectral representation includes three echo signals indicative of three objects (an echo signal 805, an echo signal 810, and an echo signal 815). However, as described above with reference to FIG. 4, the three echo signals may have been caused by a single object. Consequently, obtaining an accurate position measurement of the object will depend on identifying an appropriate one of the three echo signals to use for a position measurement. In accordance with an embodiment, an accurate position measurement of the object may be carried out by performing an interference mitigation procedure to identify the two signal artifacts among the three echo signals.

FIG. 8B illustrates an example representation of a result of a sensing procedure carried out by use of a PC-FMCW signal encoded with a phase code having a code length (Nc) of 64. A certain level of interference mitigation is achieved as a result of the spectrum spreading caused by the encoding. It can be discerned that the echo signal 805 indicates the target object (for example, target object 310 shown in FIG. 4) and the other two signals are signal artifacts. The PC code that is appropriate for decoding the echo signal 805 will be inappropriate for decoding the other two echo signals (echo signal 810 and echo signal 815). The use of an inappropriate code for decoding the echo signal 810 and the echo signal 815 (which are signal artifacts in this example), leads to the fuzzy spectral representations of the two echo signals.

FIG. 8C illustrates another example representation of a result of a sensing procedure carried out by use of a PC-FMCW signal encoded with a phase code having a code length (Nc) of 512. A higher level of interference mitigation is achieved as a result of the spectrum spreading caused by use of the code length (Nc) of 512 in comparison to the code length (Nc) of 64 described above. The echo signal 805 in this case is even more distinguishable over the noise-like spectral representations of the signal artifacts. The trade-off between using the phase code having a code length (Nc) of 512 and the phase code having a code length (Nc) of 64 is indicated by an increase in the level of the side lobes (greater level of noise).

FIGS. 8B and 8C illustrate how interference mitigation can be obtained by using a PC-FMCW signal and how a level of interference mitigation can be raised by increasing the code length. However, the beneficial aspects associated with interference mitigation by use of PC-FMCW signals may be offset, to at least some extent, by factors such as higher implementation cost and/or greater complexity. Consequently, in accordance with the disclosure, a two-dimensional (2D) scrambled PC-FMCW signal can be generated and used for sensing operations. The 2D scrambled FMCW code, which is based on scrambling an FMCW signal with a range-domain scrambling code and a Doppler-domain scrambling sequence, can offer advantages provided by an FMCW signal (low complexity and cost) combined with advantages provided by a PC-FMCW signal (interference mitigation). Further details pertaining to an 2D scrambled FMCW signal in accordance with the disclosure are provided below.

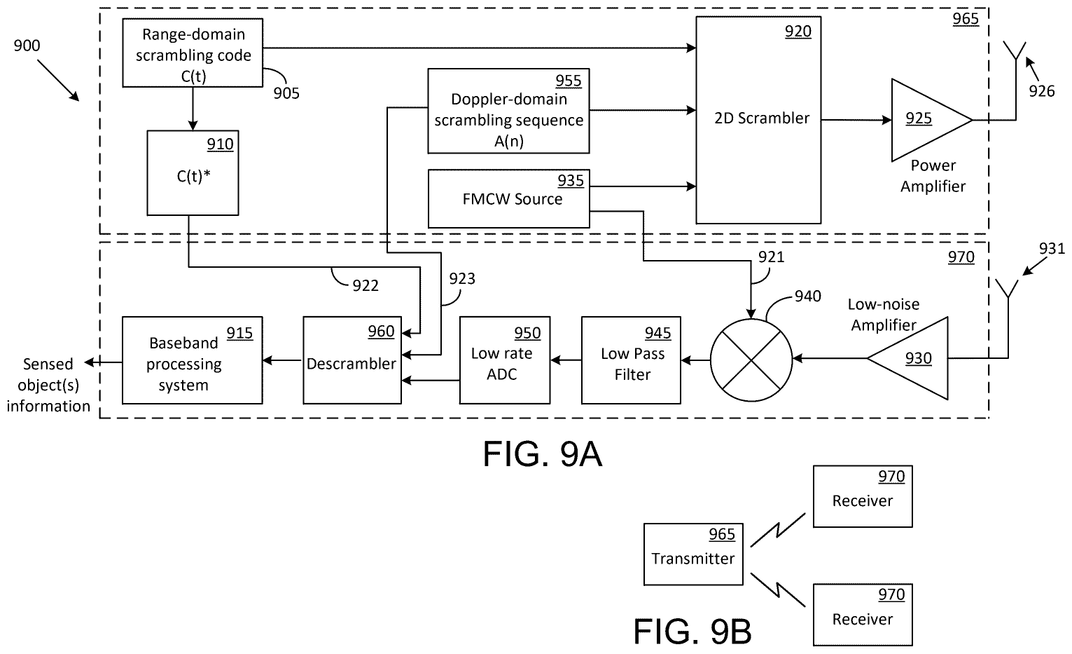

FIG. 9A shows some example functional blocks of a 2D scrambled FMCW transceiver 900 in accordance with an embodiment. In an example embodiment, the 2D scrambled FMCW transceiver 900 can be configured to perform the sensing operations described above with reference to the RF sensing system 305 shown in FIG. 3. A transmitter 965 portion of the 2D scrambled FMCW transceiver 900 includes a 2D scrambler 920 that generates a 2D scrambled FMCW signal based on encoding a wideband FMCW signal with a range-domain scrambling code and a Doppler-domain scrambling sequence.

The wideband FMCW signal can be generated by a wideband FMCW source 935 (a frequency synthesizer, for example). The range-domain scrambling code can be generated by a range-domain scrambling code generator 905. The Doppler-domain scrambling sequence can be generated by a Doppler-domain scrambling sequence generator 955. In an example embodiment, the range-domain scrambling code generator 905, the Doppler-domain scrambling sequence generator 955, and the 2D scrambler 920 are implemented in the form of software code stored in a memory and executed by a processor.

The 2D scrambler 920 modulates the wideband FMCW signal provided by the wideband FMCW source 935 with the phase code provided by the range-domain scrambling code generator 905 and the Doppler-domain scrambling sequence provided by the Doppler-domain scrambling sequence generator 955. In an example implementation, the phase code can be based on a numeric code sequence. The 2D scrambled FMCW signal produced by the 2D scrambler 920 can be transmitted out of the 2D scrambled FMCW transceiver 900 via an RF power amplifier 925 and an antenna 926. Further details pertaining to the phase code, the Doppler-domain scrambling sequence, and modulation of the wideband FM signal (which may be alternatively referred to as encoding of the wideband FM signal), are provided below.

A receiver 970 portion of the 2D scrambled FMCW transceiver 900 includes a mixer 940 that down-converts a 2D scrambled FMCW received via an antenna 931 and a low-noise amplifier 930 coupled to the antenna 931. As a part of a sensing operation, the received 2D scrambled FMCW can be an echo signal received in response to transmission of the 2D scrambled FMCW signal. The mixer 940 down-converts the received 2D scrambled FMCW signal into an analog demodulated signal occupying a bandwidth that is narrower than the bandwidth of the received 2D scrambled FMCW signal. The down-conversion may be carried out by use of the wideband FMCW signal that can be provided to the mixer 940 by the wideband FMCW source 935 via a line 921 in one embodiment, and via information contained in a configuration message in another embodiment. Some details pertaining to configuration messages are provided below.

The analog demodulated signal is propagated through a low pass filter 945 that removes some undesired signal components (high-frequency noise, outside an operating bandwidth of the 2D scrambled FMCW transceiver 900, for example). The filtered analog signal is coupled into a low-rate analog-to-digital converter (ADC) 950 for digitizing.

The output of the low-rate ADC 950 is in a digital format that can be operated upon by a descrambler 960. The descrambler 960 removes the 2D scrambling performed by the 2D scrambler 920 upon the transmitted RF signal. As indicated above, the 2D scrambler 920 modulates the wideband FMCW signal provided by the wideband FMCW source 935 with the phase code provided by the range-domain scrambling code generator 905 and the Doppler-domain scrambling sequence provided by the Doppler-domain scrambling sequence generator 955. Additional inputs into the descrambler 960 can be the Doppler-domain scrambling sequence produced by the Doppler-domain scrambling sequence generator 955 and a conjugate version 910 of the range-domain scrambling code produced by the range-domain scrambling code generator 905.

The use of the conjugate version 910 of the Doppler-domain scrambling sequence by the baseband processing system 915 provides protection against malignant entities who may be unable to decode the received 2D scrambled FMCW signal due to the 2D modulation. More particularly, the 2D modulation offers a dual advantage in terms of the malignant entity having to identify not merely the Doppler-domain scrambling sequence but also the range domain scrambling code used by the 2D scrambler 920 for generating the 2D scrambled FMCW signal.

The conjugate version 910 of the range-domain scrambling code and/or the range-domain scrambling code produced by the range-domain scrambling code generator 905 may be provided to the descrambler 960 via a line 922 in one embodiment and via a configuration message in another embodiment. The Doppler-domain scrambling sequence produced by the Doppler-domain scrambling sequence generator 955 may be provided to the descrambler 960 via a line 923 in one embodiment and via a configuration message in another embodiment.

The descrambled signal produced by the descrambler 960 is coupled into a baseband processing system 915. The baseband processing system 915 performs operations that include decoding the analog demodulated signal that was produced by the 2D scrambler 920 based on the 2D modulation procedure described above.

The sensed object(s) information produced by the baseband processing system 915 can include information related to, for example, detection of one or more objects, a distance/range/angle at which an object is detected, a speed of movement of an object (if moving), and/or a direction of arrival (DoA) estimation.

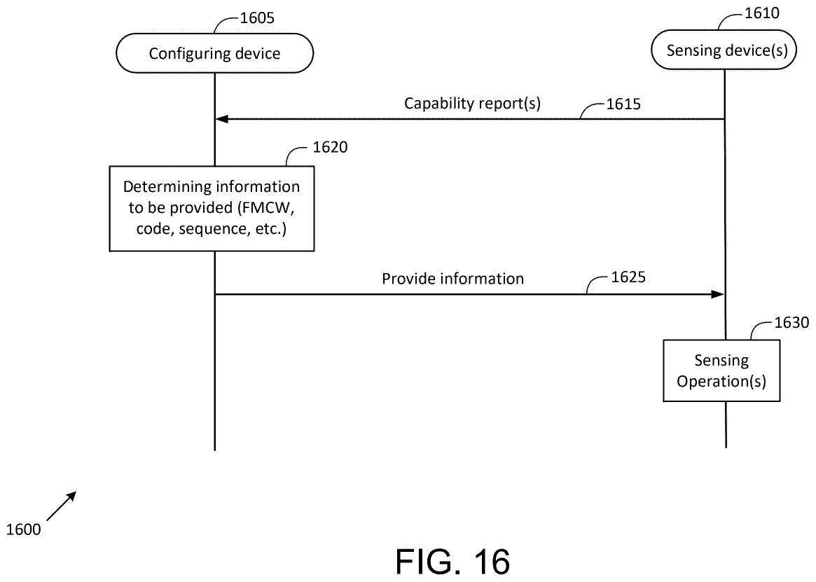

FIG. 9A that is described above pertains to a monostatic sensing configurate where a single transmitter and a single receiver is used. The description is further applicable to multi-static sensing where two or more transmitters and two or more receivers are configured to perform a sensing operation in accordance with the disclosure. In an example configuration, one or more of the transmitters/receivers can be included in a first sensing node and the other transmitters/receivers can be included in a second sensing node. Thus, for a bistatic sensing configuration, a first transmitter and/or a first receiver can be a part of a first sensing node and a second transmitter and/or a second receiver can be a part of a second sensing node. In such configurations, the range-domain scrambling code, the Doppler-domain scrambling sequence, the FMCW signal, and other information, may be communicated via messaging as described below with reference to FIG. 16.

FIG. 9B illustrates an example multi-static configuration that may be used for performing various operations in accordance with the disclosure. In this example, a single transmitter (such as, for example, the transmitter 965 described above) communicates with multiple receivers (in this example, two receivers, each of which can be the receiver 970 described above). Each of the two receivers can use information provided by the transmitter 965 (range-domain scrambling code, the Doppler-domain scrambling sequence, the FMCW signal, etc.) to perform a sensing operation as described herein.

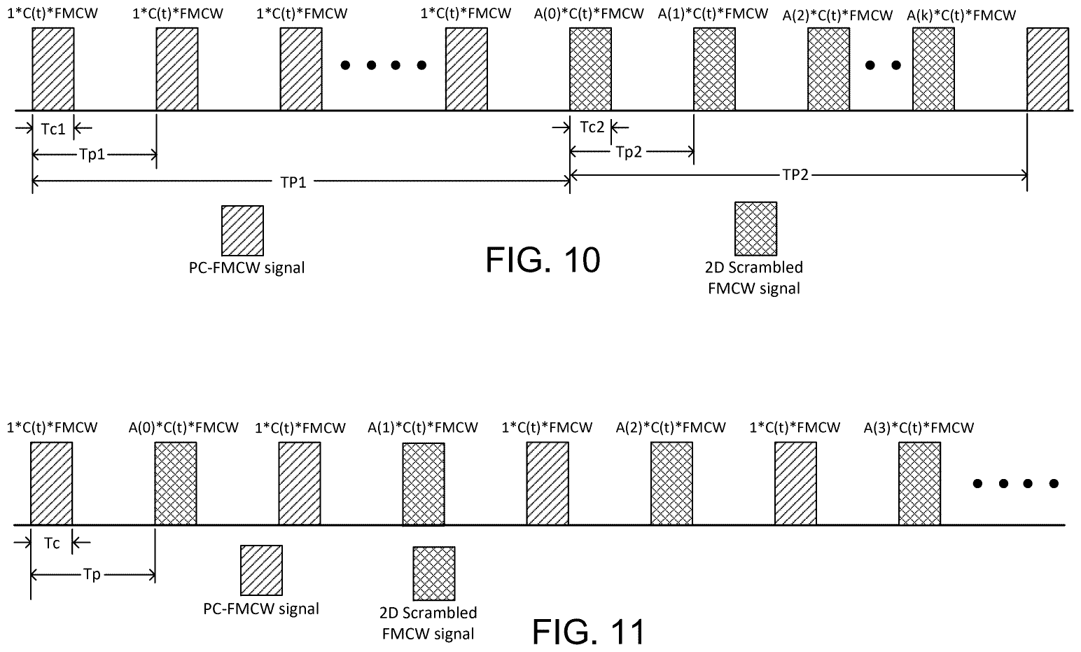

FIG. 10 illustrates a first example sense signal transmission sequence in accordance with an embodiment. The sense signal transmission sequence involves transmitting of a PC-FMCW signal in a first repetitive transmitting pattern, and transmitting a 2D scrambled FMCW signal in a second repetitive transmitting pattern that does not overlap the first repetitive transmitting pattern.

As indicated above, the PC-FMCW signal can be generated based on a wideband FMCW signal provided to the 2D scrambler 920 by the wideband FMCW source 935. In an example implementation, the 2D scrambled FMCW transceiver 900 transmits the PC-FMCW signal in the first repetitive transmitting pattern based on configuring the range-domain scrambling code generator 905 to provide an “all-ones” sequence to the 2D scrambler 920.

The 2D scrambled FMCW signal that is transmitted in the second repetitive transmitting pattern can be represented by the following equation, which indicates a two dimension (2D) scrambling of a wideband FMCW signal in accordance with the disclosure:

$$x ( t - {nT}_{p} ) = A ( n ) C ( t ) cos ( 2 π ( {f}_{c} + \frac{S}{2} t ) t + {ϕ}_{0} ) rect ( \frac{t - {T}_{c} / 2}{{T}_{c}} )$$

A first scrambling dimension indicated by the term “C(t)” represents a range domain and a second scrambling dimension indicated by the term “A(n)” represents a Doppler dimension that spans multiple range domains. The first scrambling dimension C(t) represents a sense waveform as follows:

$${\sum }_{l = I}^{L} exp ( j {ϕ}_{l} ) rect ( \frac{t - ( l - \frac{1}{2} ) \cdot {T}_{c} / L}{{T}_{c} / L} )$$

The term “L” represents a partitioning of an FMCW signal into “L” parts, wherein each part is modulated with a different phase. The term “A” represents a sequence (s₁, s₂, s₃, . . . sₖ) that can be modulated into (ϕ₁, ϕ₂, ϕ₃ . . . ϕ_{L}). For example, if ϕ₁€ {0, 1} then each ϕ₁ represents one bit, if ϕ₁€ {0, π/2, π, 3π/2} then each ϕ₁ represents two bits, and so on. The term “rect

$$( \frac{t - {T}_{c} / 2}{{T}_{c}} )$$

” represents a pulse centered at X and having a width Y.

The second scrambling dimension “A(n)” represents a phase for the n^{th} FMCW signal. The term “Tp” represents a time interval between two adjacent FMCW signals. A legacy FMCW signal can be indicated as A(n)=1 and C(t)=1.

In an example implementation, a range domain scrambling code may be numeric code. The numeric code may be based, for example, on a sensing node ID, a user equipment (UE) ID, or a cell ID. Hashing functions may be applied when converting such IDs into the range domain scrambling code. The range domain scrambling code, which can be independent of a Doppler-domain scrambling sequence, may be based on time and/or frequency resource allocation parameters associated with a sensing device. Hashing functions may be applied when converting such IDs into the Doppler-domain scrambling sequence.

In another example implementation, a Doppler-domain scrambling sequence may be based, for example, on a sensing node ID, a user equipment (UE) ID, or a cell ID. Hashing functions may be applied when converting such IDs into the Doppler-domain scrambling sequence. The range domain scrambling code, which can be independent of the Doppler-domain scrambling sequence, may be based on time and/or frequency resource allocation parameters associated with a sensing device. Hashing functions may be applied when converting such IDs into the range domain scrambling sequence.

As indicated above, the 2D scrambled FMCW transceiver 900 transmits the PC-FMCW signal in the first repetitive transmitting pattern. Each PC-FMCW signal burst in the first repetitive transmitting pattern extends over a time period Tc1 and has a periodicity indicated by Tp1. The terms Tc1, Tp1, and TP1 can be understood in view of the description provided above with reference to the two dimension (2D) scrambling equation.

The 2D scrambled FMCW transceiver 900 can transmit the 2D scrambled FMCW signal in the second repetitive transmitting pattern based on configuring the range-domain scrambling code generator 905 to provide a phase code to the 2D scrambler 920 over a second period of time (TP2) and subsequent time periods corresponding to the second repetitive transmitting pattern. The 2D scrambled FMCW signal may be transmitted based on each 2D scrambled FMCW signal burst extending over a time period Tc2 and having a periodicity indicated by Tp2. In an example implementation, Tc2 can be different than Tc1 and/or Tp2 can be different than Tp1. In another example implementation, Tc2 can be equal to Tc1 and/or Tp2 equal to Tp1.

A signal that is received in response to transmission of the PC-FMCW signal (first repetitive transmitting pattern) can be evaluated for detecting a target object. For example, the reflected RF signal 314, which is described above with reference to FIGS. 3 and 4 and which can be an PC-FMCW signal, can be evaluated for detecting the target object 310 shown in FIGS. 3 and 4. A position of the target object 310 can be determined accurately if no signal artifacts interfere with the decoding of the reflected RF signal 314.

However, in some scenarios, one or more signal artifacts may be present along with the reflected RF signal 314, thus leading to ambiguity in determining the position of the target object. In such scenario, the 2D scrambled FMCW signal can be transmitted in the second repetitive transmitting pattern so as to spread the interference over a Doppler domain (as illustrated in FIGS. 8B and 8C). The interference mitigation offered by use of the 2D scrambled FMCW signal allows distinguishing the target object in the presence of signal artifacts.

In an example embodiment, wherein multiple sensing nodes may be performing sensing operations, two sensing nodes may use substantially identical PC-FMCW signals and different 2D scrambled FMCW signals in accordance with the disclosure. For example, a first sensing node may transmit a first PC-FMCW signal over the first period of time (TP1). The first PC-FMCW signal can be produced by modulating a first CW signal with a first range scrambling sequence. The sensing node may further transmit a first 2D scrambled FMCW signal over the second period of time (TP2). The first 2D scrambled FMCW signal may be produced by modulating the first PC-FMCW signal with a first phase code having a first pattern and first code length.

A second sensing node may use a second PC-FMCW signal that can be substantially identical to the first PC-FMCW signal used by the first sensing node and a second 2D scrambled FMCW signal that is different than the first 2D scrambled FMCW signal used by the first sensing node. The second 2D scrambled FMCW signal may be produced by modulating the second FMCW signal with a second phase code having a second pattern and/or second code length that is different than the first pattern and/or first code length. The second PC-FMCW signal can be transmitted over the first period of time (TP1) (or over a different period of time TP3), and the second 2D scrambled FMCW signal transmitted over the second period of time (TP2) (or over a different period of time TP4).

In another example embodiment, wherein multiple sensing nodes may be performing sensing operations, two sensing nodes may use substantially identical 2D PC-FMCW signals and different 2D scrambled FMCW signals in accordance with the disclosure. For example, a first sensing node may transmit a first PC-FMCW signal over the first period of time (TP1). The first PC-FMCW signal can be produced by modulating a first CW signal with a first range scrambling sequence. The sensing node may transmit a first 2D scrambled FMCW signal over the second period of time (TP2). The first 2D scrambled FMCW signal may be produced by modulating the first FMCW signal with a first phase code having a first pattern and first code length.

A second sensing node may use a second PC-FMCW signal that is different than the first PC-FMCW signal used by the first sensing node (different chirp slope, for example), and a second 2D scrambled FMCW signal that is substantially identical to the first 2D scrambled FMCW signal used by the first sensing node. The second PC-FMCW signal may be produced by modulating the first CW signal (or a second CW signal) with a second range scrambling sequence that is different than the first range scrambling sequence. The second PC-FMCW signal can be transmitted over the first period of time (TP1) (or over a different period of time TP3), and the second 2D scrambled FMCW signal transmitted over the second period of time (TP2) (or over a different period of time TP4).

FIG. 11 illustrates a second example sense signal transmission sequence in accordance with an embodiment. The sense signal transmission sequence involves transmitting a PC-FMCW signal in a first repetitive transmitting pattern and transmitting a 2D scrambled FMCW signal in a second repetitive transmitting pattern that is interspersed with the first repetitive transmitting pattern. In the illustrated example, each PC-FMCW signal transmission is straddled by a 2D scrambled FMCW signal (or vice-versa) to form a A-B-A-B-A-B transmission pattern, where A corresponds to an FMCW signal and B corresponds to a 2D PC-FMCW signal. In other implementations, a different transmission pattern can be used (A-A-B-B-A-A-B-B . . . , for example).

A signal that is received in response to transmission of the interspersed PC-FMCW and 2D scrambled FMCW signals can be evaluated for detecting a target object (such as, for example, the target object 310 shown in FIGS. 3 and 4). The evaluation may be carried out based on aprioi knowledge of the transmission pattern.

Interference mitigation in this case is minimized or eliminated because other sensing nodes do not have information of the 2D scrambled FMCW signal (chirp slope, for example), as well as that of the transmission pattern.

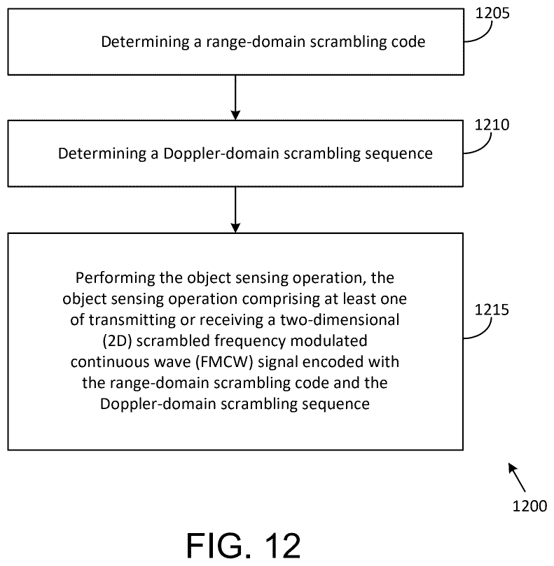

FIG. 12 shows a flowchart 1200 of a method for performing an object sensing operation in accordance with the disclosure. Means for performing the functionality illustrated in one or more of the blocks of the flowchart 1200 may be performed by hardware and/or software components of a user device such as described herein (mobile devices 145, UE 205, UE1305, etc.) or an RF sensing system (such as the RF sensing system 205).

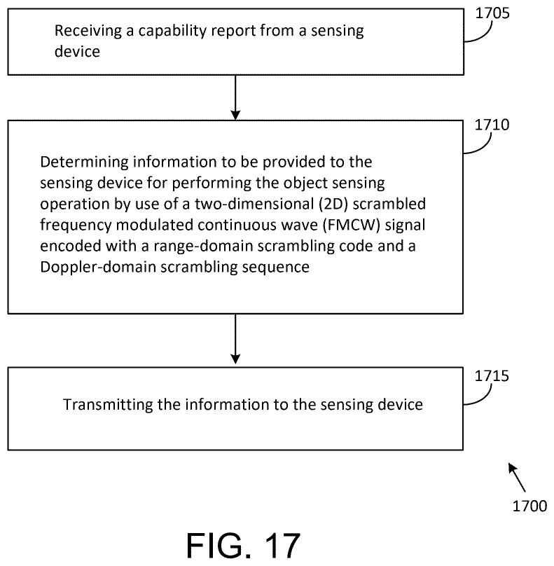

At block 1205, the functionality can include determining a range-domain scrambling code. In an example embodiment, the range domain scrambling code can be determined based on a configuration message received from a configuring device. The range-domain scrambling code, which can be included in the configuration message, can be generated, for example, by a range-domain scrambling code generator 905 that is described above with reference to FIG. 9A. Some additional details associated with the configuration message are provided below with reference to FIGS. 16 and 17.

At block 1210, the functionality can include determining a Doppler-domain scrambling sequence. In an example embodiment, the Doppler-domain scrambling sequence can also be determined based on the configuration message received from the configuring device. The Doppler-domain scrambling sequence, which can be included in the configuration message, can be generated, for example, by the Doppler-domain scrambling sequence generator 955 that is described above with reference to FIG. 9A. In an example embodiment, the range-domain scrambling code generator 905, the Doppler-domain scrambling sequence generator 955, and the 2D scrambler 920 are implemented in the form of software code stored in a memory and executed by a processor.

At block 1215 the functionality can include performing the object sensing operation. The object sensing operation may include functions such as transmitting and/or receiving a two-dimensional (2D) scrambled frequency modulated continuous wave (FMCW) signal encoded with the range-domain scrambling code and the Doppler-domain scrambling sequence.

In an example implementation, the object sensing operation can be a multi-static object sensing operation performed by using a plurality of transmitters and/or a plurality of receivers. As described above, monostatic sensing involves the use of a single device as a transmitter (of RF signals) and receiver (of reflected signals), bistatic sensing involves the use of a first device as a transmitter and a second device as a receiver, and multi-static sensing involves the use of a plurality of transmitters and/or a plurality of receivers.

In an example embodiment, the 2D scrambled FMCW signal is modulated with the range-domain scrambling code and the Doppler-domain scrambling sequence over each time period of a set of time periods. FIGS. 10 and 11 illustrate two examples of such sets of time periods.

In an example embodiment, the flowchart 1200 can further include a functionality pertaining to generating information associated with the 2D scrambled FMCW signal, wherein the information includes the range-domain scrambling code and/or the Doppler-domain scrambling sequence, and another functionality pertaining to performing the object sensing operation based at least in part on receiving the 2D scrambled FMCW signal and using the information to demodulate the received 2D scrambled FMCW signal. These aspects are described above with reference to FIG. 9A and other figures.

In an example embodiment, the flowchart 1200 can further include a functionality pertaining to generating the 2D scrambled FMCW signal by encoding an FMCW signal with the range-domain scrambling code and the Doppler-domain scrambling sequence, and another functionality pertaining to transmitting the 2D scrambled FMCW signal.

In an example embodiment, the functionality described above with reference to the flowchart 1200 can include determining the range-domain scrambling code based on determining a sequence of phase-modulated signaling bits, and determining the Doppler-domain scrambling sequence based on selecting a numerical sequence that is uniquely associated with a sensing device. The object sensing operation can further include transmitting the 2D scrambled FMCW signal encoded with the sequence of phase-modulated signaling bits and the Doppler-domain scrambling sequence, wherein the Doppler-domain scrambling sequence is based on the numerical sequence. These aspects are described above with reference to FIG. 9A and other figures.

In an example embodiment, the functionality described above with reference to the flowchart 1200 can include performing the object sensing operation based on transmitting the 2D scrambled FMCW signal, receiving an echo signal in response to transmitting the 2D scrambled FMCW signal, and sensing a target object based on evaluating the echo signal. This aspect is described above with respect to FIG. 4 and other figures.

In an example embodiment, the functionality described above with reference to the flowchart 1200 can include performing the object sensing operation based on transmitting an FMCW sense signal, receiving a first echo signal in response to transmitting the FMCW sense signal, detecting one or more signal artifacts along with the first echo signal, transmitting the 2D scrambled FMCW signal based at least in part on detecting the one or more signal artifacts, receiving a second echo signal in response to transmitting the 2D scrambled FMCW signal, and sensing a target object based on distinguishing the second echo signal from the one or more signal artifacts. In an example implementation, transmitting the FMCW sense signal can involve transmitting the FMCW sense signal in a first repetitive transmitting sequence and transmitting the 2D scrambled FMCW signal in a second repetitive transmitting sequence that does not overlap the first repetitive transmitting sequence (as illustrated in FIG. 10). In another example implementation, transmitting the FMCW sense signal can involve transmitting the FMCW sense signal in a first repetitive transmitting sequence and transmitting the 2D scrambled FMCW signal in a second repetitive transmitting sequence that is interspersed with the first repetitive transmitting sequence (as illustrated in FIG. 11).

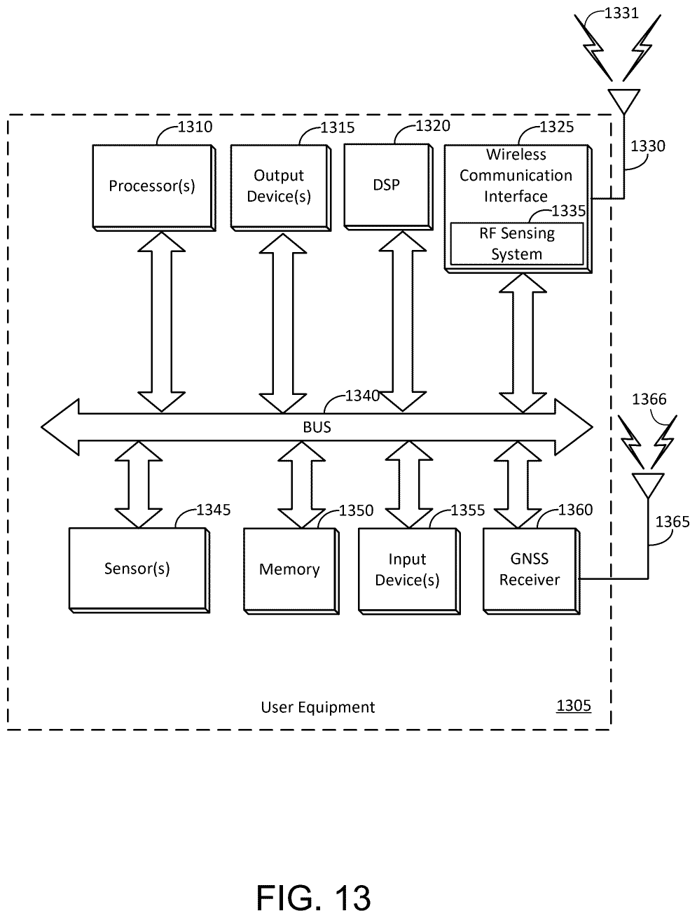

FIG. 13 shows a block diagram of a user equipment 1305 in accordance an embodiment of the disclosure. For example, user equipment 1305 may correspond the mobile device 105 shown in FIG. 1 or the UE 205 shown in FIG. 2. Further, as described below, the user equipment 1305 may implement an RF sensing system 1335, which can include the 2D scrambled FMCW transceiver 900 described above with respect to FIG. 9A. It should be noted that FIG. 13 is meant only to provide a generalized illustration of various components, any or all of which may be utilized as appropriate. Furthermore, as previously noted, the functionality of the UE discussed in the previously described embodiments may be executed by one or more of the hardware and/or software components illustrated in FIG. 13.

The user equipment 1305 is shown comprising hardware elements that can be electrically coupled via a bus 1340 (or may otherwise be in communication, as appropriate). The hardware elements may include a processor(s) 1310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1310 may comprise one or more processing units, which may be housed in a single integrated circuit (IC) or multiple ICs. As shown in FIG. 13, some embodiments may have a separate DSP 1320, depending on desired functionality. Sensing operations based on wireless communication may be provided in the processor(s) 1310 and/or wireless communication interface 1325 (discussed below). The user equipment 1305 also can include one or more input devices 1355, which can include without limitation one or more keyboards, touch screens, touch pads, microphones, buttons, dials, switches, and/or the like; and one or more output devices 1315, which can include without limitation one or more displays (e.g., touch screens), light emitting diodes (LEDs), speakers, and/or the like.

The user equipment 1305 may also include a wireless communication interface 1325, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the user equipment 1305 to communicate and/or perform various operations as described in the embodiments above, with respect to WLAN and/or cellular technologies. The wireless communication interface 1325 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 1330 that send and/or receive wireless signals 1331. According to some embodiments, the wireless communication antenna(s) 1330 may comprise a plurality of discrete antennas, antenna arrays, or any combination thereof. The antenna(s) 1330 may be capable of transmitting and receiving wireless signals using beams (e.g., Tx beams and Rx beams). Beam formation may be performed using digital and/or analog beam formation techniques, with respective digital and/or analog circuitry. The wireless communication interface 1325 may include such circuitry.

As noted above, the mobile device 105 and/or the UE 205 may implement an RF sensing system 1335. The RF sensing system 1335 may comprise the hardware and/or software elements described above with respect to FIG. 9A. As illustrated in FIG. 13 and noted above, some or all of the RF sensing system 1335 may be implemented within a wireless communication interface 1325, which may utilize certain components for both communication and RF sensing. That said, embodiments are not so limited. Alternative embodiments may implement some or all of the RF sensing system 1335 separate from the wireless communication interface 1325 (e.g., in cases where RF sensing may utilize different frequencies and/or different hardware/software components then the wireless communication interface 1325).

Depending on desired functionality, the wireless communication interface 1325 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The user equipment 1305 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The user equipment 1305 can further include sensor(s) 1345. Sensor(s) 1345 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain sensing-related measurements and/or other information. Sensors 1345 may be used, for example, to detect an object and various characteristics associated with the object.

Embodiments of the user equipment 1305 may also include a Global Navigation Satellite System (GNSS) receiver 1360 capable of receiving signals 1366 from one or more GNSS satellites using an antenna 1365 (which could be the same as antenna 1330). Positioning based on GNSS signal measurement can be utilized to complement and/or incorporate the techniques described herein. The GNSS receiver 1360 can extract a position of the user equipment 1305, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1360 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1360 is illustrated in FIG. 13 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1310, DSP 1320, and/or a processor within the wireless communication interface 1325 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1310 or DSP 1320.

The user equipment 1305 may further include and/or be in communication with a memory 1350. The memory 1350 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1350 of the user equipment 1305 also can comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1350 that are executable by the user equipment 1305 (and/or processor(s) 1310 or DSP 1320 within user equipment 1305). In some embodiments, then, such code and/or instructions can be used to configure and/or adapt a general-purpose computer (or other device) to perform one or more operations in accordance with the described methods.

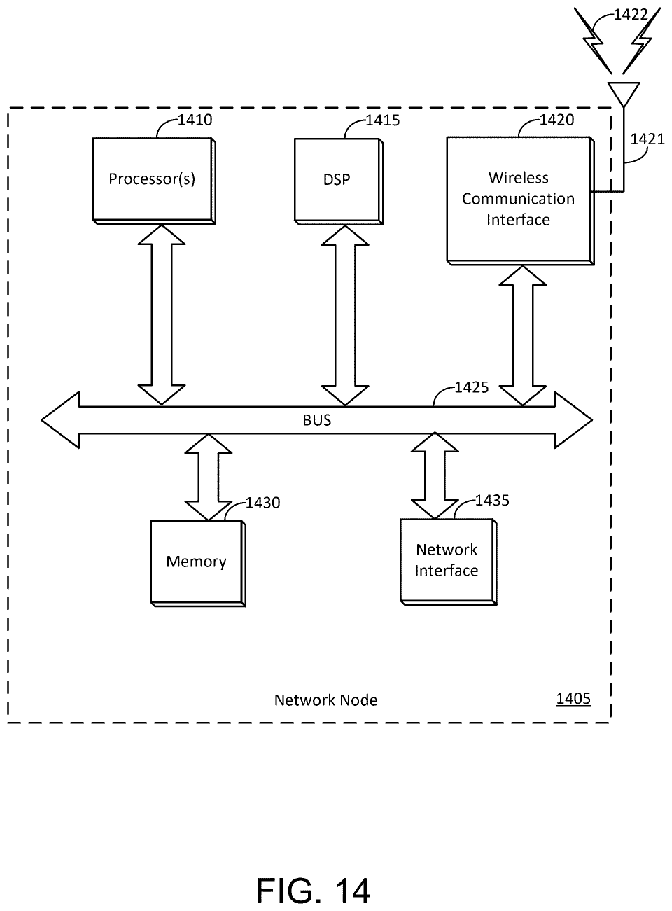

FIG. 14 is a block diagram of a network node 1405 in accordance an embodiment of the disclosure. According to some embodiments, the network node 1405 may function as a configuring node as described herein. As such, the network node 1405 may be capable of performing some or all of the functionality described in the method shown in FIG. 12. It should be noted that FIG. 14 is meant only to provide a generalized illustration of various components, any or all of which may be utilized as appropriate. In some embodiments, the network node 1405 may correspond to the gNB 210, the ng-eNB 214, ANF 215, or the SMF221 shown in FIG. 2 and/or (more generally) a TRP. In some cases, the network node 1405 may comprise multiple TRPs—e.g. with each TRP associated with a different antenna or a different antenna array of the network node 1405. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by the network node 1405 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 14.

The network node 1405 is shown comprising hardware elements that can be electrically coupled via a bus 1425 (or may otherwise be in communication, as appropriate). The hardware elements may include a processor(s) 1410 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 14, some embodiments may have a separate DSP 1415, depending on desired functionality. The network node 1405 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The network node 1405 might also include a wireless communication interface 1420, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the network node 1405 to communicate as described herein. The wireless communication interface 1420 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1421 that send and/or receive wireless signals 1422. According to some embodiments, one or more wireless communication antenna(s) 1421 may comprise one or more antenna arrays, which may be capable of beamforming.

The network node 1405 may also include a network interface 1435, which can include support of wireline communication technologies. The network interface 1435 may include a modem, network card, chipset, and/or the like. The network interface 1435 may include one or more input and/or output communication interfaces to permit data to be exchanged with a network, communication network servers, computer systems, and/or any other electronic devices described herein.

In many embodiments, the network node 1405 may further comprise a memory 1430. The memory 1430 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1430 of the network node 1405 also may comprise software elements (not shown in FIG. 14), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1430 that are executable by the network node 1405 (and/or processor(s) 1410 or DSP 1415 within network node 1405). In some embodiments, then, such code and/or instructions can be used to configure and/or adapt a general-purpose computer (or other device) to perform one or more operations in accordance with the described methods.

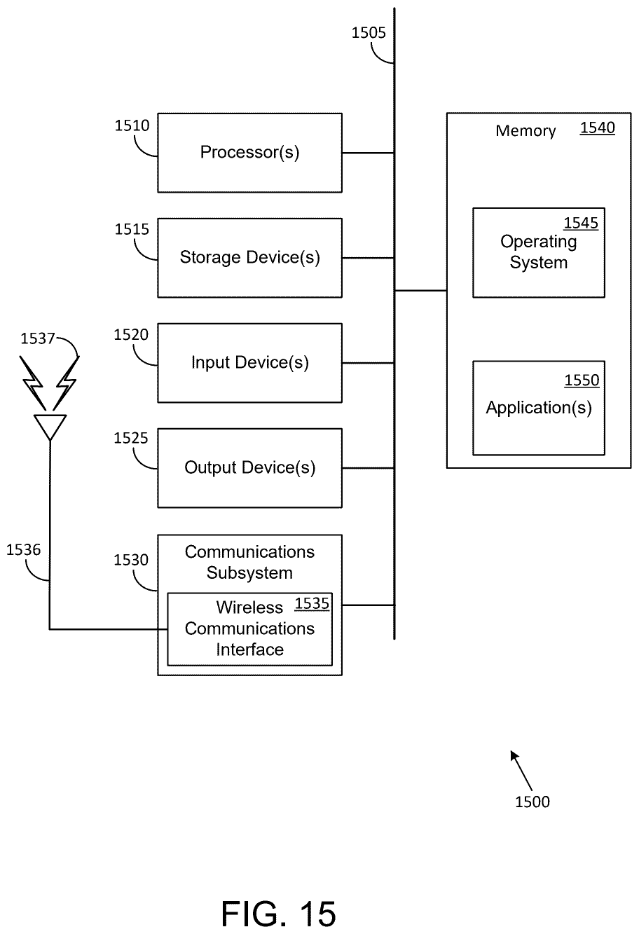

FIG. 15 is a block diagram of an embodiment of a computer system 1500, which may be used, in whole or in part, to provide the functions of one or more components and/or devices as described in the embodiments herein. The computer system 1500, for example, may be utilized within and/or executed by a server (e.g., SMF 221), which may perform the functions of a configuring node. It should be noted that FIG. 15 is meant only to provide a generalized illustration of various components, any or all of which may be utilized as appropriate. FIG. 15, therefore, broadly illustrates how individual system elements may be implemented in a relatively separated or relatively more integrated manner. In addition, it can be noted that components illustrated by FIG. 15 can be localized to a single device and/or distributed among various networked devices, which may be disposed at different geographical locations.

The computer system 1500 is shown comprising hardware elements that can be electrically coupled via a bus 1505 (or may otherwise be in communication, as appropriate). The hardware elements may include processor(s) 1510, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1500 also may comprise one or more input devices 1520, which may comprise without limitation a mouse, a keyboard, a camera, a microphone, and/or the like; and one or more output devices 1525, which may comprise without limitation a display device, a printer, and/or the like.

The computer system 1500 may further include (and/or be in communication with) one or more non-transitory storage devices 1515, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1500 may also include a communications subsystem 1530, which may comprise wireless communication technologies managed and controlled by a wireless communication interface 1535, as well as wired technologies (such as Ethernet, coaxial communications, universal serial bus (USB), and the like). The wireless communication interface 1535 may comprise one or more wireless transceivers that may send and receive wireless signals 1537 (e.g., signals according to 5G NR or LTE) via wireless antenna(s) 1536. Thus the communications subsystem 1530 may comprise a modem, a network card (wireless or wired), an infrared communication device, a wireless communication device, and/or a chipset, and/or the like, which may enable the computer system 1500 to communicate on any or all of the communication networks described herein to any device on the respective network, including UE, base stations and/or other transmission reception points (TRPs), satellites, and/or any other electronic devices described herein. Hence, the communications subsystem 1530 may be used to receive and send data as described in the embodiments herein.

In many embodiments, the computer system 1500 will further comprise a working memory 1540, which may comprise a RAM or ROM device, as described above. Software elements, shown as being located within the working memory 1540, may comprise an operating system 1545, device drivers, executable libraries, and/or other code, such as one or more applications 1550, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1515 described above. In some cases, the storage medium might be incorporated within a computer system, such as computer system 1500. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1500 and/or might take the form of source and/or installable code, which, upon compilation and/or installation on the computer system 1500 (e.g., using any of a variety of generally available compilers, installation programs, compression/decompression utilities, etc.), then takes the form of executable code.

FIG. 16 illustrates an example message flow 1600 that may be associated with performing an RF sensing operation in accordance with the disclosure. The RF sensing may be performed based on communications between a configuring device 1605 and sensing device(s) 1610. In some embodiments, the configuring device 1605 may be a base station (e.g., a base station 120 in FIG. 1, a gNB 210 in FIG. 2, and/or a base station 310 in FIG. 3). In some cases the configuring device 1605 can be a server, such as, for example, the SMF 221 and/or the LMF 220 (shown in FIG. 2) that can communicate via one or more gNBs 210. In some embodiments, the sensing device(s) 1610 can be a device such as, for example, the mobile device 105 shown in FIGS. 1 and 3, and/or a UE 205 shown in FIG. 2). A sensing device used in a monostatic configuration can include a transmitter and a receiver, or can include a transceiver such as, for example, the transceiver 900 shown in FIG. 9A. In a multi-static configuration, some or all of these devices can be located at separate locations.

Arrow 1615 represents the sensing device(s) 1610 transmitting to the configuring device 1605, one or more capability reports. In an example implementation, the one or more capability reports may be transmitted to the configuring device 1605 in response to a request received by the sensing device(s) 1610 from the configuring device 1605 for performing a sensing operation.

In an example embodiment, a capability report may indicate a capability of the sensing device(s) 1610 to perform RF sensing based on a 2D modulated PC-FMCW signal in accordance with the disclosure. The capability report may, for example, provide information such as an availability of an RF sensing system that includes a transceiver 900 such as shown in FIG. 9. In an example embodiment, in addition to, or in lieu of, the capability report, the arrow 1615 can further represent a request for information to enable the sensing device(s) 1610 to perform RF sensing by using a 2D modulated PC-FMCW signal in accordance with the disclosure. In some embodiments, in the case of bi-static or multi-static sensing, each of multiple sensing device(s) 1610 may specify, through their respective capability reports, their ability to perform RF sensing by using a 2D modulated PC-FMCW signal in accordance with the disclosure.

In some embodiments, if the sensing device(s) 1610 transmitting the capability report is capable of performing the RF sensing, the capability report may also include one or more sets of proposed RF sensing configuration parameters associated with beamforming, for example. In some embodiments, the one or more sets of proposed RF sensing configuration parameters may include indications of a number of bits per phase shifter used for generating a plurality of phase patterns and analog beamforming architecture parameters (e.g., among a set of feasible options, such as ULA/Uniform Planar Array (UPA) with 8 or 64 elements).

At block 1620, the configuring device 1605 may determine a format and other particulars for conveying information such as the ones described above with respect to line 921, line 922, and line 923 shown in FIG. 9A. Further, as indicated above, the information can include the conjugate version 910 of the range-domain scrambling code and/or the range-domain scrambling code produced by the range-domain scrambling code generator 905, the Doppler-domain scrambling sequence produced by the Doppler-domain scrambling, and the wideband FMCW signal produced by the wideband FMCW source 935. The configuring device 1605 may further determine an RF sensing configuration based on one or more sets of proposed RF sensing configuration parameters. The RF sensing configuration may be determined based on the use of a two-dimensional (2D) scrambled frequency modulated continuous wave (FMCW) signal encoded with a range-domain scrambling code and a Doppler-domain scrambling sequence for performing an RF sensing operation.

In an example embodiment, the RF sensing configuration may indicate a sense signal transmission sequence in accordance with an embodiment. Two example sense signal transmission sequences are described above with reference to FIG. 10 and FIG. 11.

At arrow 1625, the information described above (range-domain scrambling code, conjugate version of the range-domain scrambling code, Doppler-domain scrambling sequence, wideband FMCW signal, etc.) and the RF sensing configuration may be transmitted to the sensing device(s) 1610. In an example embodiment, this information, and/or the RF sensing configuration, may be transmitted from the configuring device 1605 to the sensing device(s) 1610 in the form of one or more configuration messages. The sensing device(s) 1610 may determine the range-domain scrambling code and/or the Doppler-domain scrambling sequence for performing an RF sensing operation based on a received configuration message.

In some instances, the configuring device 1605 may provide assistance information to the sensing device(s) 1610. The assistance may involve instructions or data that facilitate the processing of incoming signals.

For example, the configuring device 1605 may communicate Tx parameter configurations to the receiving device to assist the signal processing. The Tx parameters may include parameters discussed above, which could include details on how to configure the transmitter for optimal performance.

At block 1630, an RF sensing operation may be performed in accordance with the RF sensing configuration and by use of the information such as the range-domain scrambling code, conjugate version of the range-domain scrambling code, Doppler-domain scrambling sequence, wideband FMCW signal, etc. that may be conveyed by the configuring device 1605 to the sensing device(s) 1610 via one or more configuration messages. This information may be used by the sensing device(s) 1610 to configure and operate a receiver (such as the receiver 970 described above).

In some embodiments, the sensing device(s) 1610 may, upon completing the sensing, report to the configuring device 1605 performance metrics associated with the sensing operation.

FIG. 17 shows a flowchart 1700 of a method for performing an object sensing operation by a configuring device in accordance with the disclosure. Means for performing the functionality illustrated in one or more of the blocks of the flowchart 1700 may be performed by hardware and/or software components of a configuring device such as described herein such as, for example, one of the gNBs 210.

At block 1705, the functionality can include receiving a capability report from a sensing device such as, for example, one of the mobile devices 145 shown in FIG. 1 or the UE 205 shown in FIG. 2. Some aspects pertaining to this functionality has been described above with reference to arrow 1615 shown in FIG. 16.

At block 1710, the functionality can include determining information to be provided to the sensing device for performing the object sensing operation by use of a two-dimensional (2D) scrambled frequency modulated continuous wave (FMCW) signal encoded with a range-domain scrambling code and a Doppler-domain scrambling sequence. Various aspects pertaining to a 2D scrambled FMCW signal are described above such as, for example, with reference to FIGS. 10 and 11.

At block 1710, the functionality can include transmitting the information to the sensing device. In an example embodiment, the information may be transmitted to the sensing device via one or more configuration messages. The sensing device may use the information for performing a sensing operation in accordance with the disclosure and as described above, for example, with reference to FIG. 3 and FIGS. 9A and 9B.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1 A method for performing an object sensing operation can include determining a range-domain scrambling code; determining a Doppler-domain scrambling sequence; and performing the object sensing operation, the object sensing operation comprising at least one of transmitting or receiving a two-dimensional (2D) scrambled frequency modulated continuous wave (FMCW) signal encoded with the range-domain scrambling code and the Doppler-domain scrambling sequence.

Clause 2 The method of clause 1, wherein the 2D scrambled FMCW signal is modulated with the range-domain scrambling code and the Doppler-domain scrambling sequence over each time period of a set of time periods, and wherein determining at least one of the range-domain scrambling code or the Doppler-domain scrambling sequence comprises receiving a configuration message containing the at least one of the range-domain scrambling code or the Doppler-domain scrambling sequence.

Clause 3 The method of clause 2, further comprising performing the object sensing operation based at least in part on receiving the 2D scrambled FMCW signal and using the at least one of the range-domain scrambling code or the Doppler-domain scrambling sequence to demodulate the received 2D scrambled FMCW signal.

Clause 4 The method of any of clauses 1-3, wherein the object sensing operation is a multi-static object sensing operation performed by using a plurality of transmitters and/or a plurality of receivers.

Clause 5 The method of clause 1, wherein performing the object sensing operation comprises generating the 2D scrambled FMCW signal by encoding an FMCW signal with the range-domain scrambling code and the Doppler-domain scrambling sequence; and transmitting the 2D scrambled FMCW signal.

Clause 6 The method of clause 1, wherein determining the range-domain scrambling code comprises determining a sequence of phase-modulated signaling bits, wherein determining the Doppler-domain scrambling sequence comprises selecting a numerical sequence that is uniquely associated with a sensing device, and wherein performing the object sensing operation comprises transmitting the 2D scrambled FMCW signal encoded with the sequence of phase-modulated signaling bits and the Doppler-domain scrambling sequence, wherein the Doppler-domain scrambling sequence is based on the numerical sequence.

Clause 7 The method of clause 1, wherein performing the object sensing operation comprises transmitting the 2D scrambled FMCW signal; receiving an echo signal in response to transmitting the 2D scrambled FMCW signal; and sensing a target object based on evaluating the echo signal.

Clause 8 The method of clause 1, wherein performing the object sensing operation comprises transmitting an FMCW sense signal; receiving a first echo signal in response to transmitting the FMCW sense signal; detecting one or more signal artifacts along with the first echo signal; and transmitting the 2D scrambled FMCW signal based at least in part on detecting the one or more signal artifacts.

Clause 9 The method of clause 8, further comprising receiving a second echo signal in response to transmitting the 2D scrambled FMCW signal; and sensing a target object based on distinguishing the second echo signal from the one or more signal artifacts.

Clause 10 The method of clause 8, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that does not overlap the first repetitive transmitting sequence.

Clause 11 The method of clause 8, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that is interspersed with the first repetitive transmitting sequence.

Clause 12 An apparatus for performing an object sensing operation, the apparatus comprising a transceiver, a memory, and one or more processors communicatively coupled with the transceiver and the memory. The one or more processors are configured to determine a range-domain scrambling code; determine a Doppler-domain scrambling sequence; and perform the object sensing operation, the object sensing operation comprising at least one of transmitting via the transceiver or receiving via the transceiver, a two-dimensional (2D) scrambled frequency modulated continuous wave (FMCW) signal encoded with the range-domain scrambling code and the Doppler-domain scrambling sequence.

Clause 13 The apparatus of clause 11, wherein the 2D scrambled FMCW signal is modulated with the range-domain scrambling code and the Doppler-domain scrambling sequence over each time period of a set of time periods, and wherein the one or more processors are configured to determine at least one of the range-domain scrambling code or the Doppler-domain scrambling sequence based on receiving a configuration message containing the at least one of the range-domain scrambling code or the Doppler-domain scrambling sequence.

Clause 14 The apparatus of clause 13, wherein the one or more processors are further configured to perform the object sensing operation based at least in part on receiving the 2D scrambled FMCW signal and using the received at least one of the range-domain scrambling code or the Doppler-domain scrambling sequence to demodulate the received 2D scrambled FMCW signal.

Clause 15 The apparatus of clause 13, wherein the object sensing operation is a multi-static object sensing operation.

Clause 16 The apparatus of clause 11, wherein performing the object sensing operation comprises generating the 2D scrambled FMCW signal by encoding an FMCW signal with the range-domain scrambling code and the Doppler-domain scrambling sequence; and transmitting the 2D scrambled FMCW signal via the transceiver.

Clause 17 The apparatus of clause 11, wherein determining the range-domain scrambling code comprises determining a sequence of phase-modulated signaling bits, wherein determining the Doppler-domain scrambling sequence comprises selecting a numerical sequence that is uniquely associated with the apparatus, and wherein performing the object sensing operation comprises transmitting the 2D scrambled FMCW signal encoded with the sequence of phase-modulated signaling bits and the Doppler-domain scrambling sequence, wherein the Doppler-domain scrambling sequence is based on the numerical sequence.

Clause 18 The apparatus of clause 11, wherein performing the object sensing operation comprises transmitting the 2D scrambled FMCW signal via the transceiver; receiving, via the transceiver, an echo signal in response to transmitting the 2D scrambled FMCW signal; and sensing a target object based on evaluating the echo signal.

Clause 19 The apparatus of clause 11, wherein performing the object sensing operation comprises transmitting an FMCW sense signal via the transceiver; receiving, via the transceiver, a first echo signal in response to transmitting the FMCW sense signal; detecting one or more signal artifacts along with the first echo signal; and transmitting the 2D scrambled FMCW signal via the transceiver, based at least in part on detecting the one or more signal artifacts.

Clause 20 The apparatus of clause 18, further comprising receiving, via the transceiver, a second echo signal in response to transmitting the 2D scrambled FMCW signal; and sensing a target object based on distinguishing the second echo signal from the one or more signal artifacts.

Clause 21 The apparatus of clause 19, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that does not overlap the first repetitive transmitting sequence.

Clause 22 The apparatus of clause 19, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that is interspersed with the first repetitive transmitting sequence.

Clause 23 A method for performing an object sensing operation by a configuring device, the method comprising receiving a capability report from a sensing device; determining information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and transmitting the information to the sensing device.

Clause 24 The method of clause 23, wherein the information transmitted to the sensing device comprises information associated with the range-domain scrambling code, information associated with the Doppler-domain scrambling sequence, and information associated with a wideband FMCW signal.

Clause 25 The method of clause 23 or 24, wherein the Doppler-domain scrambling sequence is based on a numerical sequence.

Clause 26 The method of clause 25, wherein the numerical sequence is uniquely associated with the sensing device.

Clause 27 The method of clause 23 or 24, wherein the information transmitted to the sensing device comprises information associated with a sense signal transmission sequence.

Clause 28 The method of clause 27, wherein the sense signal transmission sequence comprises a PC-FMCW signal having a first repetitive sequence and a 2D scrambled FMCW signal having a second repetitive transmitting sequence that one of a) overlaps the first repetitive sequence or b) is interspersed with the first repetitive sequence.

Clause 29 An apparatus for performing an object sensing operation, the apparatus comprising a transceiver; a memory; and one or more processors communicatively coupled with the transceiver and the memory, the one or more processors configured to receive a capability report from a sensing device; determine information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and transmit the information to the sensing device.

Clause 30 The apparatus of clause 27, wherein the information transmitted to the sensing device comprises information associated with a sense signal transmission sequence.

Clause 31 The apparatus of clause 29 or 30, wherein the sense signal transmission sequence comprises a PC-FMCW signal having a first repetitive sequence and a 2D scrambled FMCW signal having a second repetitive transmitting sequence that one of a) overlaps the first repetitive sequence or b) is interspersed with the first repetitive sequence.

Clause 32 The apparatus of clause 29 or 30, wherein the Doppler-domain scrambling sequence is based on a numerical sequence that is uniquely associated with the sensing device.

Clause 33 A device for performing an object sensing operation, the device comprising means for determining a range-domain scrambling code; means for determining a Doppler-domain scrambling sequence; and means for performing the object sensing operation, the object sensing operation comprising at least one of transmitting or receiving a two-dimensional (2D) scrambled frequency modulated continuous wave (FMCW) signal encoded with the range-domain scrambling code and the Doppler-domain scrambling sequence.

Clause 34 The device of clause 33, wherein the 2D scrambled FMCW signal is modulated with the range-domain scrambling code and the Doppler-domain scrambling sequence over each time period of a set of time periods.

Clause 35 The device of clause 33 or 34, further comprising means for generating information associated with the 2D scrambled FMCW signal, the information comprising at least one of the range-domain scrambling code or the Doppler-domain scrambling sequence; and means for performing the object sensing operation based at least in part on receiving the 2D scrambled FMCW signal and using the information to demodulate the received 2D scrambled FMCW signal.

Clause 36 The device of clause 33 or 34, wherein determining the range-domain scrambling code comprises determining a sequence of phase-modulated signaling bits, wherein determining the Doppler-domain scrambling sequence comprises selecting a numerical sequence that is uniquely associated with a sensing device, and wherein the device further comprises means for performing the object sensing operation based on transmitting the 2D scrambled FMCW signal encoded with the sequence of phase-modulated signaling bits and the Doppler-domain scrambling sequence, wherein the Doppler-domain scrambling sequence is based on the numerical sequence.

Clause 37 The device of clause 33, further comprising means for transmitting an FMCW sense signal; means for receiving a first echo signal in response to transmitting the FMCW sense signal; means for detecting one or more signal artifacts along with the first echo signal; means for transmitting the 2D scrambled FMCW signal based at least in part on detecting the one or more signal artifacts; means for receiving a second echo signal in response to transmitting the 2D scrambled FMCW signal; and means for sensing a target object based on distinguishing the second echo signal from the one or more signal artifacts.

Clause 38 The device of clause 37, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that does not overlap the first repetitive transmitting sequence.

Clause 39 The device of clause 37, wherein transmitting the FMCW sense signal comprises transmitting the FMCW sense signal in a first repetitive transmitting sequence, and wherein transmitting the 2D scrambled FMCW signal comprises transmitting the 2D scrambled FMCW signal in a second repetitive transmitting sequence that is interspersed with the first repetitive transmitting sequence.

Clause 40 A non-transitory computer-readable medium storing instructions for performing an object sensing operation, the object sensing operation comprising determining a range-domain scrambling code; determining a Doppler-domain scrambling sequence; and performing the object sensing operation, the object sensing operation comprising at least one of transmitting or receiving a two-dimensional (2D) scrambled frequency modulated continuous wave (FMCW) signal encoded with the range-domain scrambling code and the Doppler-domain scrambling sequence.

Clause 41 The non-transitory computer-readable medium of clause 40, wherein the 2D scrambled FMCW signal is modulated with the range-domain scrambling code and the Doppler-domain scrambling sequence over each time period of a set of time periods.

Clause 42 The non-transitory computer-readable medium of clause 40, wherein the object sensing operation comprising further comprises generating information associated with the 2D scrambled FMCW signal, the information comprising at least one of the range-domain scrambling code or the Doppler-domain scrambling sequence; and performing the object sensing operation based at least in part on receiving the 2D scrambled FMCW signal and using the information to demodulate the received 2D scrambled FMCW signal.

What is claimed is:

1. A method for performing an object sensing operation by a sensing device, the method comprising:
determining a range-domain scrambling code;
determining a Doppler-domain scrambling sequence; and
performing the object sensing operation, the object sensing operation comprising at least one of transmitting or receiving a two-dimensional (2D) scrambled frequency modulated continuous wave (FMCW) signal encoded with the range-domain scrambling code and the Doppler-domain scrambling sequence.

2. The method of claim 1, wherein the 2D scrambled FMCW signal is modulated with the range-domain scrambling code and the Doppler-domain scrambling sequence over each time period of a set of time periods, and wherein determining at least one of the range-domain scrambling code or the Doppler-domain scrambling sequence comprises receiving a configuration message containing the at least one of the range-domain scrambling code or the Doppler-domain scrambling sequence.

3. The method of claim 2, further comprising:
performing the object sensing operation based at least in part on receiving the 2D scrambled FMCW signal and using the at least one of the range-domain scrambling code or the Doppler-domain scrambling sequence to demodulate the received 2D scrambled FMCW signal.

4. The method of claim 3, wherein the object sensing operation is a multi-static object sensing operation performed by using a plurality of transmitters and/or a plurality of receivers.

5. The method of claim 1, wherein performing the object sensing operation comprises:
generating the 2D scrambled FMCW signal by encoding an FMCW signal with the range-domain scrambling code and the Doppler-domain scrambling sequence; and
transmitting the 2D scrambled FMCW signal.

6. The method of claim 1, wherein determining the range-domain scrambling code comprises determining a sequence of phase-modulated signaling bits, wherein determining the Doppler-domain scrambling sequence comprises selecting a numerical sequence that is uniquely associated with a sensing device, and wherein performing the object sensing operation comprises:
transmitting the 2D scrambled FMCW signal encoded with the sequence of phase-modulated signaling bits and the Doppler-domain scrambling sequence, wherein the Doppler-domain scrambling sequence is based on the numerical sequence.

7. The method of claim 1, wherein performing the object sensing operation comprises:
transmitting the 2D scrambled FMCW signal;
receiving an echo signal in response to transmitting the 2D scrambled FMCW signal; and
sensing a target object based on evaluating the echo signal.

8. The method of claim 1, wherein performing the object sensing operation comprises:
transmitting a PC-FMCW signal;
receiving a first echo signal in response to transmitting the PC-FMCW signal;
detecting one or more signal artifacts along with the first echo signal; and
transmitting the 2D scrambled FMCW signal based at least in part on detecting the one or more signal artifacts.

9. The method of claim 8, wherein transmitting the PC-FMCW signal comprises transmitting the PC-FMCW signal in a first repetitive transmitting sequence, and wherein transmitting the 2D scrambled FMCW signal comprises transmitting the 2D scrambled FMCW signal in a second repetitive transmitting sequence that does not overlap the first repetitive transmitting sequence.

10. The method of claim 8, wherein transmitting the PC-FMCW signal comprises transmitting the PC-FMCW signal in a first repetitive transmitting sequence, and wherein transmitting the 2D scrambled FMCW signal comprises transmitting the 2D scrambled FMCW signal in a second repetitive transmitting sequence that is interspersed with the first repetitive transmitting sequence.

11. An apparatus for performing an object sensing operation, the apparatus comprising:
a transceiver;
a memory; and
one or more processors communicatively coupled with the transceiver and the memory, the one or more processors configured to:
determine a range-domain scrambling code;
determine a Doppler-domain scrambling sequence; and
perform the object sensing operation, the object sensing operation comprising at least one of transmitting via the transceiver or receiving via the transceiver, a two-dimensional (2D) scrambled frequency modulated continuous wave (FMCW) signal encoded with the range-domain scrambling code and the Doppler-domain scrambling sequence.

12. The apparatus of claim 11, wherein the 2D scrambled FMCW signal is modulated with the range-domain scrambling code and the Doppler-domain scrambling sequence over each time period of a set of time periods, and wherein the one or more processors are configured to determine at least one of the range-domain scrambling code or the Doppler-domain scrambling sequence based on receiving a configuration message containing the at least one of the range-domain scrambling code or the Doppler-domain scrambling sequence.

13. The apparatus of claim 12, wherein the one or more processors are further configured to:
perform the object sensing operation based at least in part on receiving the 2D scrambled FMCW signal and using the received at least one of the range-domain scrambling code or the Doppler-domain scrambling sequence to demodulate the received 2D scrambled FMCW signal.

14. The apparatus of claim 13, wherein the object sensing operation is a multi-static object sensing operation.

15. The apparatus of claim 11, wherein performing the object sensing operation comprises:
generating the 2D scrambled FMCW signal by encoding an FMCW signal with the range-domain scrambling code and the Doppler-domain scrambling sequence; and
transmitting the 2D scrambled FMCW signal via the transceiver.

16. The apparatus of claim 11, wherein determining the range-domain scrambling code comprises determining a sequence of phase-modulated signaling bits, wherein determining the Doppler-domain scrambling sequence comprises selecting a numerical sequence that is uniquely associated with the apparatus, and wherein performing the object sensing operation comprises:
transmitting the 2D scrambled FMCW signal encoded with the sequence of phase-modulated signaling bits and the Doppler-domain scrambling sequence, wherein the Doppler-domain scrambling sequence is based on the numerical sequence.

17. The apparatus of claim 11, wherein performing the object sensing operation comprises:
transmitting the 2D scrambled FMCW signal via the transceiver;
receiving, via the transceiver, an echo signal in response to transmitting the 2D scrambled FMCW signal; and
sensing a target object based on evaluating the echo signal.

18. The apparatus of claim 11, wherein performing the object sensing operation comprises:
transmitting a PC-FMCW signal via the transceiver;
receiving, via the transceiver, a first echo signal in response to transmitting the PC-FMCW signal;
detecting one or more signal artifacts along with the first echo signal; and
transmitting the 2D scrambled FMCW signal via the transceiver, based at least in part on detecting the one or more signal artifacts.

19. The apparatus of claim 18, wherein transmitting the PC-FMCW signal comprises transmitting the PC-FMCW signal in a first repetitive transmitting sequence, and wherein transmitting the 2D scrambled FMCW signal comprises transmitting the 2D scrambled FMCW signal in a second repetitive transmitting sequence that does not overlap the first repetitive transmitting sequence.

20. The apparatus of claim 18, wherein transmitting the PC-FMCW signal comprises transmitting the PC-FMCW signal in a first repetitive transmitting sequence, and wherein transmitting the 2D scrambled FMCW signal comprises transmitting the 2D scrambled FMCW signal in a second repetitive transmitting sequence that is interspersed with the first repetitive transmitting sequence.

21. A method for performing an object sensing operation by a configuring device, the method comprising:
receiving a capability report from a sensing device;
determining information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and
transmitting the information to the sensing device.

22. The method of claim 21, wherein the information transmitted to the sensing device comprises information associated with the range-domain scrambling code, information associated with the Doppler-domain scrambling sequence, and information associated with a wideband FMCW signal.

23. The method of claim 22, wherein the Doppler-domain scrambling sequence is based on a numerical sequence.

24. The method of claim 23, wherein the numerical sequence is uniquely associated with the sensing device.

25. The method of claim 21, wherein the information transmitted to the sensing device comprises information associated with a sense signal transmission sequence.

26. The method of claim 25, wherein the sense signal transmission sequence comprises a PC-FMCW signal having a first repetitive sequence and a 2D scrambled FMCW signal having a second repetitive transmitting sequence that one of a) overlaps the first repetitive sequence or b) is interspersed with the first repetitive sequence.

27. An apparatus for performing an object sensing operation, the apparatus comprising:
a transceiver;
a memory; and
one or more processors communicatively coupled with the transceiver and the memory, the one or more processors configured to:
receive a capability report from a sensing device via the transceiver;
determine information to be provided to the sensing device for performing the object sensing operation by use of a two-dimensional (2D) scrambled frequency modulated continuous wave (FMCW) signal encoded with a range-domain scrambling code and a Doppler-domain scrambling sequence; and
transmit the information to the sensing device via the transceiver.

28. The apparatus of claim 27, wherein the information transmitted to the sensing device comprises information associated with a sense signal transmission sequence.

29. The apparatus of claim 28, wherein the sense signal transmission sequence comprises a PC-FMCW signal having a first repetitive sequence and a 2D scrambled FMCW signal having a second repetitive transmitting sequence that one of a) overlaps the first repetitive sequence or b) is interspersed with the first repetitive sequence.

30. The apparatus of claim 27, wherein the Doppler-domain scrambling sequence is based on a numerical sequence that is uniquely associated with the sensing device.
